(19) United States
(12) Patent Application Publication
(10) Pub. No.: US 2019/0057060 A1
(43) Pub. Date: Feb. 21, 2019

(54) RECONFIGURABLE FABRIC DATA ROUTING

(71) Applicant: Wave Computing, Inc., Campbell, CA (US)

(72) Inventor: Christopher John Nicol, Campbell, CA (US)

(21) Appl. No.: 16/104,586

(22) Filed: Aug. 17, 2018

Related U.S. Application Data
(60) Provisional application No. 62/547,769, filed on Aug. 19, 2017.
(60) Provisional application No. 62/577,902, filed on Oct. 27, 2017.
(60) Provisional application No. 62/579,616, filed on Oct. 31, 2017.
(60) Provisional application No. 62/594,563, filed on Dec. 5, 2017.
(60) Provisional application No. 62/594,582, filed on Dec. 5, 2017.
(60) Provisional application No. 62/611,588, filed on Dec. 29, 2017.
(60) Provisional application No. 62/611,600, filed on Dec. 29, 2017.
(60) Provisional application No. 62/636,309, filed on Feb. 28, 2018.
(60) Provisional application No. 62/637,614, filed on Mar. 2, 2018.
(60) Provisional application No. 62/650,758, filed on Mar. 30, 2018.
(60) Provisional application No. 62/650,425, filed on Mar. 30, 2018.
(60) Provisional application No. 62/679,046, filed on Jun. 1, 2018.
(60) Provisional application No. 62/679,172, filed on Jun. 1, 2018.
(60) Provisional application No. 62/692,993, filed on Jul. 2, 2018.
(60) Provisional application No. 62/694,984, filed on Jul. 7, 2018.

(51) Int. Cl. G06F 15/80; G06F 9/445

(52) U.S. Cl. CPC G06F 15/80; G06F 9/44505

(57) ABSTRACT

Techniques are disclosed for reconfigurable fabric data routing. A plurality of kernels is allocated across a reconfigurable fabric comprised of a plurality of clusters, wherein the plurality of kernels includes at least a first kernel and a second kernel. The first kernel is mounted in a first set of clusters within the plurality of clusters. The second kernel is mounted in a second set of clusters within the plurality of clusters. Available routing is determined through the second set of clusters. A porosity map through the second set of clusters is calculated based on the available routing through the second set of clusters. Data is sent through the second set of clusters to the first set of clusters based on the porosity map. Data input needs are evaluated for the first kernel. The available routing is controlled with instructions in circular buffers within the second set of clusters.

### RELATED APPLICATIONS

This application claims the benefit of U.S. provisional patent applications “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to data manipulation and more particularly to reconfigurable fabric data routing.

### BACKGROUND

Data is an omnipresent and frequently monetized resource that is collected for a wide array of purposes. Emerging processor architectures and software techniques enable the collection of vast amounts of data. Researchers, business people, and governments collect and analyze vast amounts of data, and gather the data into datasets, typically referred to as “big data”. The analysis of big data is essentially intractable using traditional or general purpose computational techniques and processors. The near-intractability arises because the sizes of datasets outstrip the capabilities of the processors and techniques employed previously. Further, data access, capture, maintenance, storage, transmission, and visualization, among other tasks, complicate the processing requirements attributable to the data analysis. These additional requirements quickly saturate the traditional systems' capacities. The data essentially would be of little or no value if there were no viable and scalable data analysis and handling techniques to meet the requirements and applications of the data. Innovative computing architectures, plus software techniques, algorithms, heuristics, and so on, are demanded. Those who own the datasets or have access to the datasets are motivated by business and research requirements to analyze the data contained within. Further purposes of the data also include business analysis; disease or infection detection, tracking, and control; crime detection and prevention; meteorology; and complex science and engineering simulations, to name but a very few. Advanced data analysis techniques are finding applications such as predictive analytics which can show consumers what they want, even before they know they do. Further approaches include applying machine learning and deep learning techniques in support of the data analysis.

Machine learning is one of many computer science disciplines that have expanded with and greatly benefited from the advent of improved processors and learning techniques. Machine learning has been described as the ability of a machine to learn about a unique dataset, without the machine having to be explicitly coded or programmed by a user to handle that dataset. Machine learning can be performed on a network such as a neural network. The neural can process the big data in order for the neural network to learn. The greater the quantity of data that is processed, the better the machine learning outcome. The processors on which the machine learning techniques can be executed are designed to handle the flow of data efficiently. These processors, which are based on data flow architectures, process data when valid data becomes available to the processors. This allows for helpful simplifications and in some cases avoids a need for a global system clock.

Reconfigurable hardware is a highly flexible and advantageous computing architecture that is well suited to processing large data sets, performing complex computations, and executing other computationally resource-intensive applications. Reconfigurable computing integrates the key features of hardware and software techniques. A reconfigurable computing architecture can be “recoded” (reprogrammed). The recoding adapts or configures the high-performance hardware architecture, much as if recoding software. A reconfigurable fabric hardware technique is directly applicable to reconfigurable computing. Reconfigurable fabrics may be arranged in configurations or topologies for the many applications that require high performance computing. Applications such as processing of big data, digital signal processing (DSP), machine learning based on neural networks, matrix or tensor computations, vector operations or Boolean manipulations, and so on, can be implemented within reconfigurable fabric. The reconfigurable fabric operates particularly well when the data can include specific types of data, large quantities of unstructured data, sample data, and the like. The reconfigurable fabrics can be coded or scheduled to achieve these and other processing techniques, and to represent a variety of efficient computer architectures.

### SUMMARY

The processing of vast quantities of data such as unstructured data is applicable to many applications. The data, which is collected into large datasets or “big data”, is processed for applications in areas such as artificial intelligence, trend analysis, machine learning (including deep learning), medical research, law enforcement, public safety, and so on. Traditional processors and processing techniques for data analysis have been decidedly deficient in handling the volumes of data. Data analysis systems designers and engineers have built or purchased faster processors, designed custom integrated circuits (chips), implemented application specific integrated circuits (ASIC), programmed field programmable gate arrays (FPGA), etc. These approaches are based on computer and chip architectures, such as Von Neumann architectures, which are focused on how control of the chip operations (control flow view) is performed, rather than the flow of data through the chips (data flow view). An alternative approach to the control flow architectures is to use a data flow architecture. In a data flow architecture, the execution of instructions, functions, subroutines, kernels, agents, apps, etc. is based on the presence or absence of valid data being available for processing by a processor. This latter approach, that of a data flow architecture, is far better suited to the tasks of handling the large amounts of unstructured data that is processed as part of the machine learning and deep learning applications. The data flow architecture obviates the need for centralized control of the processing since no system clocks or centralized control signals are required. A data flow architecture can be implemented using a reconfigurable fabric.

Reconfigurable fabric data routing is used for data manipulation. A computer-implemented method for data manipulation is disclosed comprising: allocating a plurality of kernels across a reconfigurable fabric comprised of a plurality of clusters, wherein the plurality of kernels includes at least a first kernel and a second kernel; mounting the first kernel in a first set of clusters within the plurality of clusters; mounting the second kernel in a second set of clusters within the plurality of clusters; determining available routing through the second set of clusters; calculating a porosity map through the second set of clusters based on the available routing through the second set of clusters; and sending data through the second set of clusters to the first set of clusters based on the porosity map. In embodiments, the mounting of the first kernel in the first set of clusters and the second kernel in the second set of clusters is a function of porosity. Some embodiments further comprise evaluating data input needs for the first kernel. In embodiments, the sending data through the second set of clusters is based on data input needs for the first kernel. Some embodiments further comprise controlling the available routing with instructions in circular buffers within the second set of clusters.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for reconfigurable fabric data routing.

FIG. 2 is a flow diagram for evaluating data input needs and data output needs.

FIG. 3 is a flow diagram for mounting a third kernel.

FIG. 4 illustrates an example data flow graph.

FIG. 5 illustrates a server allocating FIFOs and processing elements.

FIG. 6 illustrates an example block diagram for kernel mapping with porosity map.

FIG. 7A shows a block diagram of a reconfigurable fabric showing clusters and fabric input/output.

FIG. 7B shows an example reconfigurable fabric with kernel 1 and kernel 2 mounted and with input and output for kernel 1 via kernel 2.

FIG. 7C shows an example reconfigurable fabric with kernel 1, kernel 2, and kernel 3 mounted, and output from kernel 1 via kernel 3.

FIG. 8 is an example illustrating a porosity map.

FIG. 9 shows a reconfigurable fabric cluster topology with route-through communication.

FIG. 10 illustrates a cluster for coarse-grained reconfigurable processing.

FIG. 11 shows a block diagram of a circular buffer.

FIG. 12 illustrates a circular buffer and processing elements.

FIG. 13 shows a deep learning block diagram.

FIG. 14 is a system diagram for data manipulation for reconfigurable fabric data routing.

### DETAILED DESCRIPTION

Techniques are disclosed for data routing within a reconfigurable computing environment. Functions, algorithms, heuristics, apps, etc., can be used to process large datasets. The large amounts of data, often referred to as “big data”, can overwhelm conventional, control-based computer hardware techniques including those based on Von Neumann techniques. The functions, algorithms, heuristics, and so on, can be described using data flow graphs. The data flow graphs can be decomposed or partitioned into smaller operations, or kernels, that can be allocated to single processing elements, clusters of processing elements, a plurality of clusters of processing elements, etc. The processing elements are included within a reconfigurable fabric. The reconfigurable fabric includes elements that can be configured as processing elements, switching elements, storage elements, and so on. The elements within the reconfigurable fabric can be organized in quads of processing elements. The configuring of the elements within the reconfigurable fabric, and the operation of the configured elements, can be controlled by rotating circular buffers. The rotating circular buffers can be statically scheduled. The reconfigurable fabric also includes ports such as input ports, output ports, and input/output (bidirectional) ports, etc., which can be used to transfer data both into and out of the reconfigurable fabric.

In a reconfigurable fabric, mesh network, distributed network, or other suitable processing topology, the multiple processing elements (PE) obtain data, process the data, store data, transfer data to other processing elements, and so on. The processing that is performed can be based on kernels which include sets of instructions that are allocated to a single PE, a cluster of PEs, a plurality of clusters of PEs, and etc. The clusters of PEs can be distributed across the reconfigurable fabric. In order for processing of the data to be performed effectively and efficiently, the data must be routed from input ports of the reconfigurable fabric, through the reconfigurable fabric, to the clusters of PEs that require the data, and from outputs of the clusters of PEs, through the reconfigurable fabric, to output ports of the reconfigurable fabric. The data is required to arrive at the designated PEs at the correct time and in the proper order. The data passing is accomplished by reconfigurable fabric data routing.

Reconfigurable fabric operation is based on data routing. A plurality of kernels is allocated across a reconfigurable fabric that includes a plurality of clusters. The plurality of kernels includes at least a first kernel and a second kernel. Other numbers of kernels can also be allocated. The first kernel is mounted in a first set of clusters within the plurality of clusters, and the second kernel is mounted in a second set of clusters within the plurality of clusters. The first kernel may or may not be in direct communication with input/output ports of the reconfigurable fabric. Available routing through the second set of clusters is determined, where the available routing can be used to send data to the first kernel mounted on the first set of clusters. A porosity map through the second set of clusters is calculated based on the available routing through the second set of clusters. The porosity map can include information regarding which elements can be configured as switching elements, available communications channels, timing constraints, data requirements, and so on. Data is sent through the second set of clusters to the first set of clusters based on the porosity map. The sending of data can be based on the data requirements of the first set of clusters.

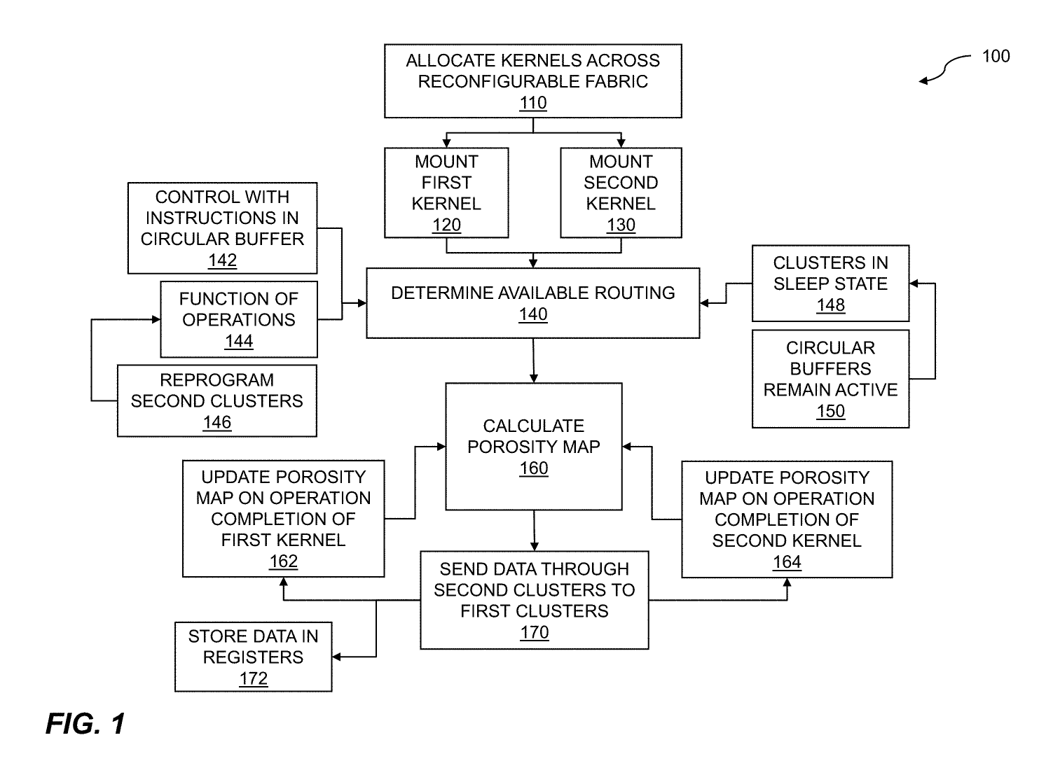

FIG. 1 is a flow diagram for reconfigurable fabric data routing. The operation of the reconfigurable fabric can include data manipulation for data routing. The flow 100 includes allocating a plurality of kernels across a reconfigurable fabric 110 comprised of a plurality of clusters, wherein the plurality of kernels includes at least a first kernel and a second kernel. The reconfigurable fabric can include communication ports for data input/output; elements including processing elements, switching elements, and storage elements; and control. In embodiments, each cluster of the plurality of clusters that can form the reconfigurable fabric can be controlled by one or more circular buffers. The circular buffers can execute instructions that can control the pluralities of clusters. The circular buffers can be the same size or different sizes. The circular buffers can circulate continuously, can be put into sleep modes, and so on. In embodiments, the one or more circular buffers are statically scheduled. Static scheduling can include repeating execution of the same code within the circular buffers until the circular buffers can be reprogrammed, and thus static scheduling is different from dynamic scheduling, where new code needs to be loaded into the circular buffers to continue the same task, such as in normal von Neumann processor architecture. Static scheduling of circular buffers is also different from FPGA programming. In FPGA programming, the hardware is loaded with a certain functionality at program time, during which the FPGA is non-functional. Statically scheduled circular buffers allow a reconfigurable fabric to perform new functions and receive updates while the fabric is running, but not while the current circular buffer instructions are being executed.

The kernels from the plurality of kernels can include code for algorithms, functions, heuristics, processes, routines, and so on. In embodiments, the plurality of kernels can include islands of machine code scheduled onto machine cycles. The kernels can include software, code segments, applications, apps, schedules, etc. In embodiments, the first kernel and the second kernel can include linked operations within the reconfigurable fabric. Linked operations can be linked in terms of execution order such as first to execute, second to execute, parallel execution, etc., in terms of data flow, and so on. The linked operations can be part of a meta-structure such as a graph. In embodiments, the linked operations can be part of a data flow graph implemented in the reconfigurable fabric. The data flow graph can comprise a network such as a neural network. In embodiments, the data flow graph implements machine learning. The machine learning can be accomplished using a deep neural network (DNN), a convolutional neural network (CNN), a recurrent neural network (RNN), and the like.

Each cluster of the plurality of clusters comprising the reconfigurable fabric can include processing elements (PE), switching elements (SE), storage elements (STE), and the like. The PEs can execute the kernels, the SEs can transfer data, the STEs can store data for processing, transfer, etc. The flow 100 includes mounting the first kernel 120 in a first set of clusters within the plurality of clusters. The clusters can include quads of processing elements, or other numbers of processing elements such as two elements, eight elements, sixteen elements, thirty-two elements, and so on. The mounting the first kernel can include loading instructions into one or more circular buffers, where the one or more circular buffers can control the PEs with which the circular buffers are associated. The flow 100 includes mounting the second kernel 130 in a second set of clusters within the plurality of clusters. Similar to the mounting the first kernel, the mounting the second kernel can include loading instructions into one or more circular buffers. In embodiments, the first set of clusters within the plurality of clusters and the second set of clusters within the plurality of clusters can be synchronized within the reconfigurable fabric. Other kernels may be mounted into other pluralities of clusters in the reconfigurable fabric. Note that not all of the kernels mounted in clusters may have direct access to ports of the reconfigurable fabric. The ports can include input ports, output ports, input/output (I/O) ports, etc. In embodiments, the first kernel mounted in the first set of clusters can lack direct access to fabric I/O ports for the reconfigurable fabric.

The flow 100 includes determining available routing 140 through the second set of clusters. Available routes through a set of clusters can be determined based on elements of a reconfigurable fabric being available to serve as switching elements, communication elements, routing elements, etc. As mentioned above, some elements of the reconfigurable fabric can be configured to act as switching elements. The SEs can be used to switch data between and among processing elements. The SEs switching can include nearest neighbor communication, non-nearest neighbor communication, etc. For example, two PEs which are not nearest neighbors are able to communicate through a SE acting as a communications intermediary. The flow 100 further includes controlling the available routing with instructions in circular buffers 142 within the second set of clusters. The instructions in the circular buffers can configure the elements to which the circular buffers are coupled as switching elements, processing elements, storage elements, and so on. The instructions in the circular buffers can execute the kernel mounted in a set of clusters. In embodiments, the available routing through the second set of clusters is a function of operations 144 being performed by the second kernel. During operations being performed by the second kernel, the elements of the reconfigurable fabric can operate on data, store data, collect data from other PEs, send data to other PEs, etc. The operating on data, storing data, collecting data, and sending data can temporarily use part or all of a route that at other times can be used for passing data through the second set of clusters. In embodiments, the available routing through the second set of clusters can change during execution of the second kernel. In other embodiments, the function of the operations being performed by the second kernel changes due to reprogramming 146 of the second set of clusters. The reprogramming the second set of clusters can include mounting a new kernel into the second set of clusters. The reprogramming the second set of clusters can include loading instructions into one or more circular buffers. Reprogramming of the second set of clusters may not change routing, porosity maps, etc. In embodiments, the reprogramming of the second set of clusters may not impact the sending of the data.

During normal operation of a data flow architecture, elements of the reconfigurable fabric can be awaiting the arrival of valid data. When valid data is not yet available for processing, switching, storing, etc., elements of the reconfigurable fabric can idle, can be placed into a sleep state, and so on. In embodiments, one or more portions of the second set of clusters are placed into a sleep state 148. Similarly, one or more portions of the first set of clusters can be placed into a sleep state. In embodiments, sections of the first set of clusters can remain active while the other sections are in a sleep state. The sections that remain active facilitate the routing of data through the clusters. These sections that remain active can have circular buffers which continue to rotate with instructions that handle the routing. While portions of the second set of clusters or portions of the first set of clusters are in a sleep state, the elements can continue to check for valid data. When valid data is available, the elements can begin operations. In order to reduce processing delay and other inefficiencies, the elements can be made ready to begin operation when the valid data arrives. Circular buffers can continue circulating so that the first instruction to be executed is the first instruction in line for execution. While portions of the second set of clusters are in a sleep state, the first set of clusters can continue to process data. In embodiments, circular buffers within the second set of clusters remain active 150 to execute the sending. The sending can include sending data through the second set of clusters to the first set of clusters.

The flow 100 includes calculating a porosity map 160 through the second set of clusters based on the available routing through the second set of clusters. The porosity map can include data relating to the set of clusters such as percent utilization, routing density, routing diversity, utilization schedule, and so on. In embodiments, the mounting of the first kernel in the first set of clusters and the second kernel in the second set of clusters is a function of porosity. The porosity map can be used to determine configurations of elements across the reconfigurable fabric. Recall that available routing through the second set of clusters can change during execution of the second kernel, and that the porosity map can change based on the variations of available routing. Available routing can also change due to reprogramming, kernel completion, and so on. The flow 100 further includes updating the porosity map based on operation completion of the first kernel 162. Completion of the first kernel can indicate that no further input data is required, no further output data will be generated, that the first kernel can be unloaded and another kernel can be loaded, and so on. The flow 100 further includes updating the porosity map based on operation completion of the second kernel 164.

The flow 100 can include sending data through the second set of clusters to the first set of clusters 170 based on the porosity map. The sending data can include sending based on the type of data, the amount of data, the distance through the second set of clusters to the first set of clusters, the distance to ports such as data ports of the reconfigurable fabric, and so on. Recall that the available routing through the second set of clusters can change during execution of the second kernel. That is, a route through the second set of clusters can be time-varying and can be based on the availability or unavailability of an element of the reconfigurable fabric. In embodiments, the flow 100 further includes storing the data in one or more registers 172 within the second set of clusters. The stored data can be transferred when a route through the second set of clusters becomes available. In embodiments, the storing in the one or more registers can be temporary in order to facilitate sending the data and avoiding congestion problems in the reconfigurable fabric.

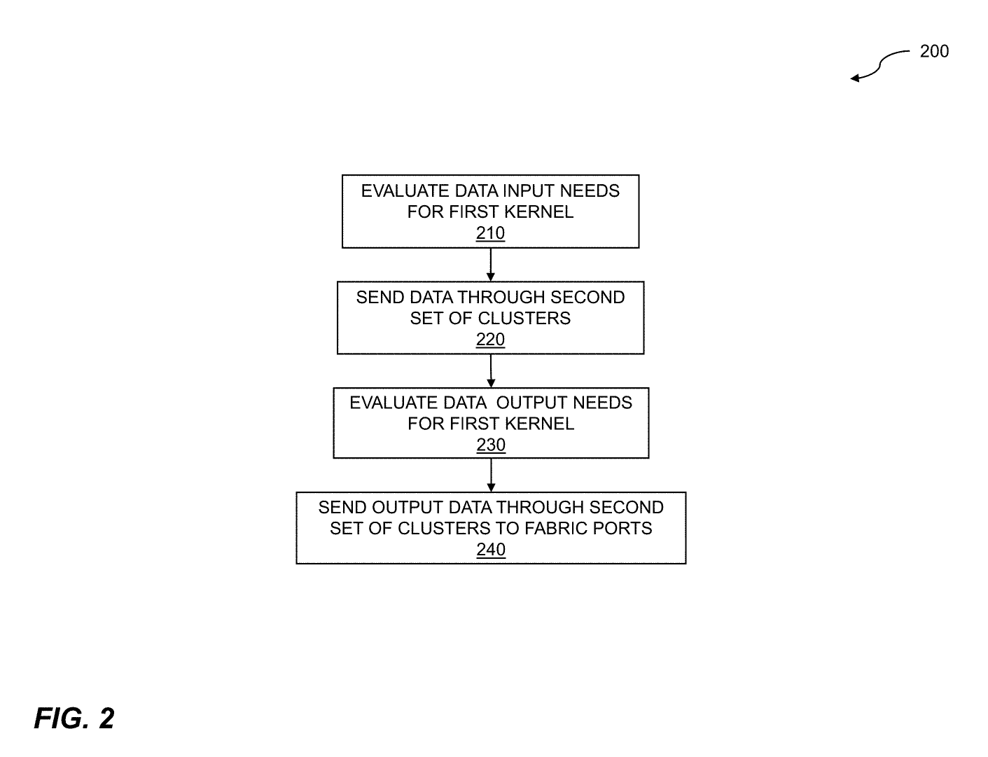

FIG. 2 is a flow diagram for evaluating data input needs and data output needs. The allocating kernels to pluralities of clusters within a reconfigurable fabric includes evaluating data requirements of the kernels. The allocating the kernels can also be based on the locations of the kernels within the reconfigurable fabric, adjacencies of kernels, and so on. The data transfer, which includes evaluating data input needs and data output needs, can be used for reconfigurable fabric data routing. A plurality of kernels is allocated across a reconfigurable fabric which includes a plurality of clusters, where the plurality of kernels includes at least a first kernel and a second kernel. The clusters can include processing elements, switching elements, storage elements, and so on. The first kernel is mounted in a first set of clusters within the plurality of clusters, and a second kernel is mounted in a second set of clusters within the plurality of clusters. Available routing through the second set of clusters is determined. A porosity map through the second set of clusters is calculated based on the available routing through the second set of clusters. Data is sent through the second set of clusters to the first set of clusters based on the porosity map.

The flow 200 includes evaluating data input needs for the first kernel 210. The data needs of a kernel can be considered when allocating a first kernel and a second kernel across pluralities of clusters within a reconfigurable fabric. The first kernel, for example, may not have direct access to input/output ports of the reconfigurable fabric. Data to the first kernel can be routed through another kernel, such as the second kernel, enabling the data to eventually reach the first kernel. The data needs of the first kernel can be evaluated for the data being sent through the second cluster to the first cluster. The data input needs for the first kernel can include the type of data to be input, the amount of data, a time at which the data is required for processing, and so on. The data can include binary data, fixed-point data, vectors, arrays, tensors, Boolean variables or vectors, and the like. The flow 200 includes sending data through the second set of clusters 220, where the sending data is based on the data input needs for the first kernel. In embodiments, the sending can be based on determining available routing through the second set of clusters. The available routing can be determined by examining the clusters to which the second kernel was assigned for elements that can be configured as switching elements (SE), available data paths, and so on.

The flow 200 includes evaluating data output needs of the first kernel 230. Both the data input and data output needs for the first kernel can include the type of data, the amount of data, a time at which the data can be sent or collected, a time at which the output data is required elsewhere, and so on. The available routing can be controlled. Embodiments include controlling the available routing with instructions in circular buffers within the second set of clusters. The circular buffers can be statically scheduled. The flow 200 includes sending output data from the first kernel mounted on the first set of clusters through the second set of clusters to fabric I/O ports 240 based on a porosity map. The porosity map can be based on operations of the second kernel, completion of operations by the second kernel, etc. In embodiments, available routing through the second set of clusters can change during execution of the second kernel. The routing through a kernel can be based on a store-and-forward technique. Further embodiments include storing the data in one or more registers within the second set of clusters. The storing the data can be accomplished using FIFOs, registers, direct memory access (DMA) techniques, and so on. In other embodiments, the storing is temporary in order to facilitate sending the data and avoiding congestion problems in the reconfigurable fabric.

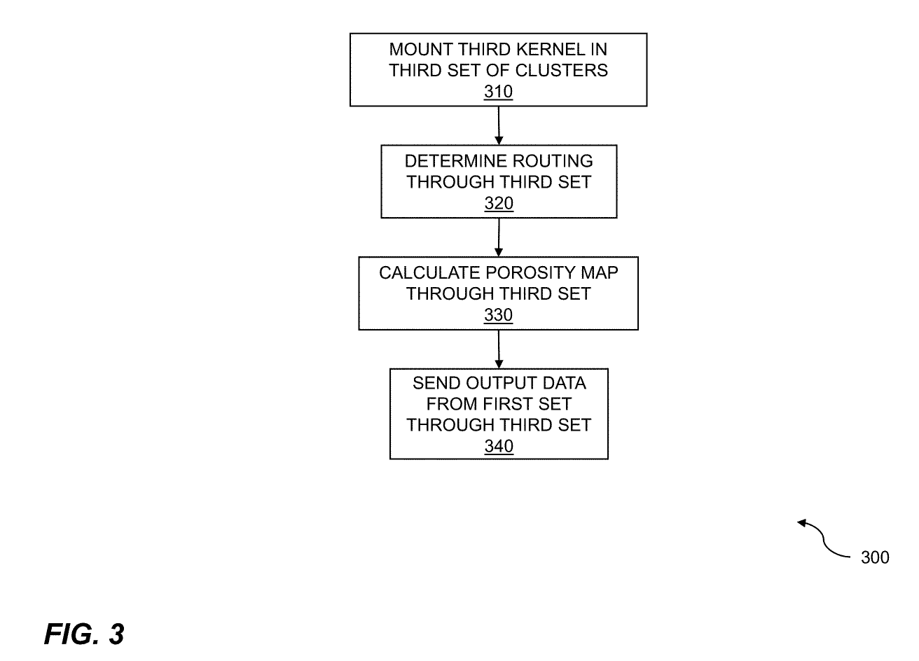

FIG. 3 is a flow diagram for mounting a third kernel. Mounting a kernel such as a third kernel or other kernel can be based on reconfigurable fabric data routing. The mounting the third kernel can be based on determining available routing through previously mounted kernels and calculating porosity maps based on the available routing. A reconfigurable fabric cluster topology with route-through communication can be used for reconfigurable fabric data routing. Software kernels are allocated across a reconfigurable fabric that includes multiple clusters, where software kernels include at least a first kernel and a second kernel. The first kernel is mounted in a first set of clusters within the multiple clusters, and the second kernel is mounted in a second set of clusters within the multiple clusters. Available routing through the second set of clusters is determined. A porosity map through the second set of clusters is calculated based on the available routing through the second set of clusters. The porosity map can indicate paths along which data can route through the second set of clusters. Data is sent through the second set of clusters to the first set of clusters based on the porosity map.

The flow 300 can include mounting a third kernel in a third set of clusters 310 within the plurality of clusters. The third kernel can be mounted adjacent to previously mounted clusters, remote from other kernels, and so on. The mounting the third kernel can be based on a quantity of clusters available for mounting within the reconfigurable fabric. The third kernel can interact with the previously mounted kernels such as exchanging data, can be independent from other kernels, etc. The flow 300 can include determining available routing 320 through the third set of clusters. The determining available routing can include identifying communications paths that are idle, elements that can be configured as switching elements, available first in first out registers or memories, and so on. The available routing can be dependent on the data needs of one or more kernels. The available routing through a given set of clusters can be a function of the operations being performed by the kernel allocated to the set of clusters. The routing through a set of clusters can change over time. In embodiments, the available routing through the set of clusters changes during execution of the kernel. The flow 300 can include calculating a porosity map 330 through the third set of clusters based on the available routing through the third set of clusters. A porosity map can include a percentage of unused elements within a cluster of elements, and the locations of the unused elements. The porosity can be used to determine the amount of data and the rate at which the data can be passed through a cluster to which a kernel has been assigned. The flow 300 can include sending output data from the first set of clusters through the third set of clusters 340 based on the porosity map for routing through the third set of clusters. The sending data can depend on available routing, amount of data to be transferred, and so on.

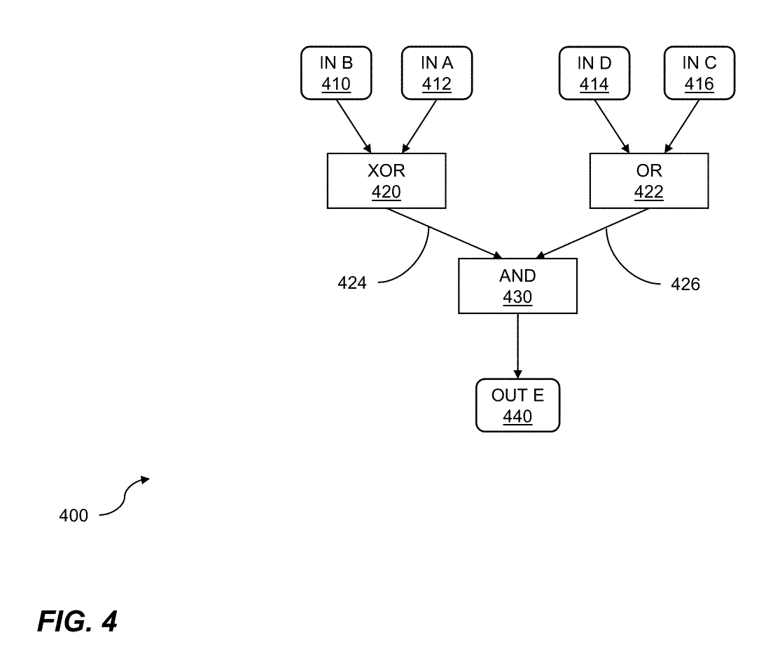

FIG. 4 illustrates an example data flow graph. A flow graph can be used for reconfigurable fabric data routing. A flow graph can include kernels or agents and can describe the flow of instructions, status, data, etc., between and among the various kernels. A plurality of kernels is allocated across a reconfigurable fabric which includes a plurality of clusters, where the plurality of kernels includes at least a first kernel and a second kernel. The clusters can include processing elements, switching elements, storage elements, and so on. The first kernel is mounted in a first set of clusters within the plurality of clusters, and a second kernel is mounted in a second set of clusters within the plurality of clusters. Available routing through the second set of clusters is determined. A porosity map through the second set of clusters is calculated based on the available routing through the second set of clusters. Data is sent through the second set of clusters to the first set of clusters based on the porosity map. The sending data through the second set of clusters can be based on input data needs for the first kernel, and available routing through the second set of clusters can change during execution of the second kernel.

The example flow graph 400 can include one or more entry, initial, or start nodes such as node B 410, node A 412, node D 414, and node C 416, for example. Any number of entry (initial) nodes can be included. The entry nodes 410, 412, 414, and 416 can handle input data, where the input data can include binary data, alphanumeric data, graphical data, arrays, tensors, vectors, and so on. For example, binary input data can include a bit, a nibble, a byte, a binary vector, and so on. The entry nodes can be connected by one or more arcs (vertices) to one or more other nodes. For example, the entry nodes B 410 and A 412 can be connected to an intermediate node 420, and the entry nodes D 414 and C 416 can be connected to another intermediate node 422. The nodes can serve any purpose appropriate to reconfigurable fabric operation linkage, including Boolean operations, mathematical operations, storage operations, and so on. For example, the intermediate node 420 can perform an XOR Boolean operation, and the intermediate node 422 can perform an OR Boolean operation. More complex Boolean operations or other operations can also be performed.

The intermediate nodes 420 and 422 of the example flow graph 400 can be connected to one or more other nodes, where the other nodes can be intermediate nodes, exit (terminal) nodes, and so on. Continuing with the example, the intermediate nodes 420 and 422 can be connected by the arcs (vertices) 424 and 426, respectively, to another intermediate node 430. As before, the intermediate node or nodes can serve any purpose appropriate to logic circuitry. For example, the intermediate node 430 can perform an AND Boolean operation. Other complex operations, Boolean operations, and so on, can also be performed. The intermediate node 430 can be connected to one or more other nodes, where the other nodes can be intermediate nodes, exit or terminal nodes, and so on. Continuing with the example, the intermediate node 430 can be connected to an exit or terminal node OUT E 440. The node E 440 can serve as an input to another flow, as a storage node or a communication node, and so on. While one flow graph is shown, many flow graphs could be similarly executed, simultaneously executed, and so on.

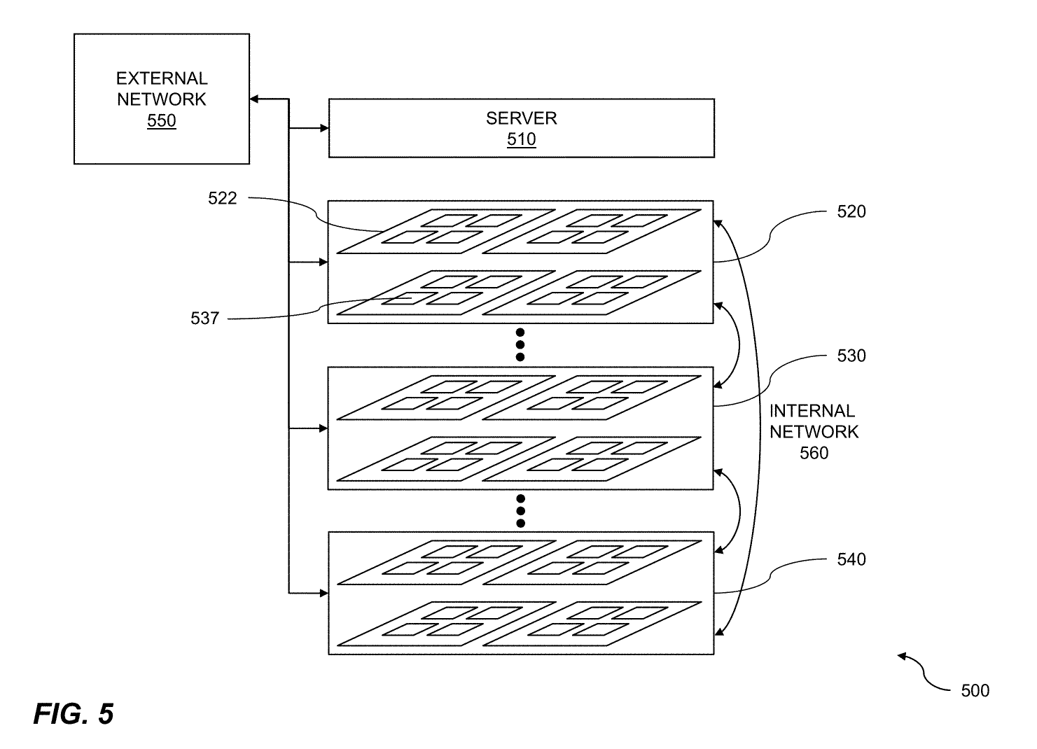

FIG. 5 shows an example server allocating a data flow graph. The data flow graph can be allocated to first in first out registers (FIFO) and processing elements. First in first out (FIFO) techniques can be used to support reconfigurable fabric data routing. The FIFOs and the processing elements can be elements within a reconfigurable fabric. The processing elements can be grouped into clusters. The processing elements can be configured to implement kernels, agents, a data flow graph, and so on, by scheduling rotating circular buffers. The circular buffers can be statically scheduled. A plurality of kernels is allocated across a reconfigurable fabric that includes a plurality of clusters, where the plurality of kernels includes at least a first kernel and a second kernel. The first kernel is mounted in a first set of clusters, and the second kernel is mounted in a second set of clusters. Available routing is determined through the second set of clusters. A porosity map through the second set of clusters is calculated based on the available routing through the second set of clusters, and data is sent through the second set of clusters to the first set of clusters.

The system 500 can allocate one or more first-in first-outs (FIFOs) and processing elements (PEs) for reconfigurable fabric data routing. The system can include a server 510 allocating FIFOs and processing elements. In embodiments, system 500 includes one or more boxes, indicated by callouts 520, 530, and 540. Each box may have one or more boards, indicated generally as 522. Each board comprises one or more chips, indicated generally as 537. Each chip may include one or more processing elements, where at least some of the processing elements may execute a process agent, a kernel, or the like. An internal network 560 allows for communication between and among the boxes such that processing elements on one box can provide and/or receive results from processing elements on another box.

The server 510 may be a computer executing programs on one or more processors based on instructions contained in a non-transitory computer readable medium. The server 510 may perform reconfiguring of a mesh networked computer system comprising a plurality of processing elements with a FIFO between one or more pairs of processing elements. In some embodiments, each pair of processing elements has a dedicated FIFO configured to pass data between the processing elements of the pair. The server 510 may receive instructions and/or input data from external network 550. The external network may provide information that includes, but is not limited to, hardware description language instructions (e.g. Verilog, VHDL, or the like), flow graphs, source code, or information in another suitable format.

The server 510 may collect performance statistics on the operation of the collection of processing elements. The performance statistics can include number of fork operations, join operations, average sleep time of a processing element, and/or a histogram of the sleep time of each processing element. Any outlier processing elements that sleep more than a predetermined threshold can be identified. In embodiments, the server can resize FIFOs or create new FIFOs to reduce the sleep time of a processing element that exceeds the predetermined threshold. Sleep time is essentially time when a processing element is not producing meaningful results, so it is generally desirable to minimize the amount of time a processing element spends in a sleep mode. In some embodiments, the server 510 may serve as an allocation manager to process requests for adding or freeing FIFOs, and/or changing the size of existing FIFOs in order to optimize operation of the processing elements.

In some embodiments, the server may receive optimization settings from the external network 550. The optimization settings may include a setting to optimize for speed, optimize for memory usage, or balance between speed and memory usage. Additionally, optimization settings may include constraints on the topology, such as a maximum number of paths that may enter or exit a processing element, maximum data block size, and other settings. Thus, the server 510 can perform a reconfiguration based on user-specified parameters via external network 550.

Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include calculation input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be a portion of a data flow graph. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were pre-programmed to enter configuration mode can be preprogrammed to exit configuration mode. When configuration mode has been exited, execution of the one or more kernels loaded onto the clusters can commence. In embodiments, clusters can be reprogrammed and during the reprogramming, switch instructions used for routing are not interfered with so that routing continues through a cluster.

Data flow processes that can be executed by data flow processor can be managed by a software stack. A software stack can include a set of subsystems, including software subsystems, which may be needed to create a software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code that can be operated on by the software development kit can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit can include a variety of tools which can be used to support a deep learning technique or other technique which requires processing of large amounts of data such as unstructured data. The SDK can support multiple machine learning techniques such as machine learning techniques based on GEMM™, sigmoid, and so on. The SDK can include a low-level virtual machine (LLVM) which can serve as a front end to the SDK. The SDK can include a simulator. The SDK can include a Boolean satisfiability solver (SAT solver). The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a flow graph.

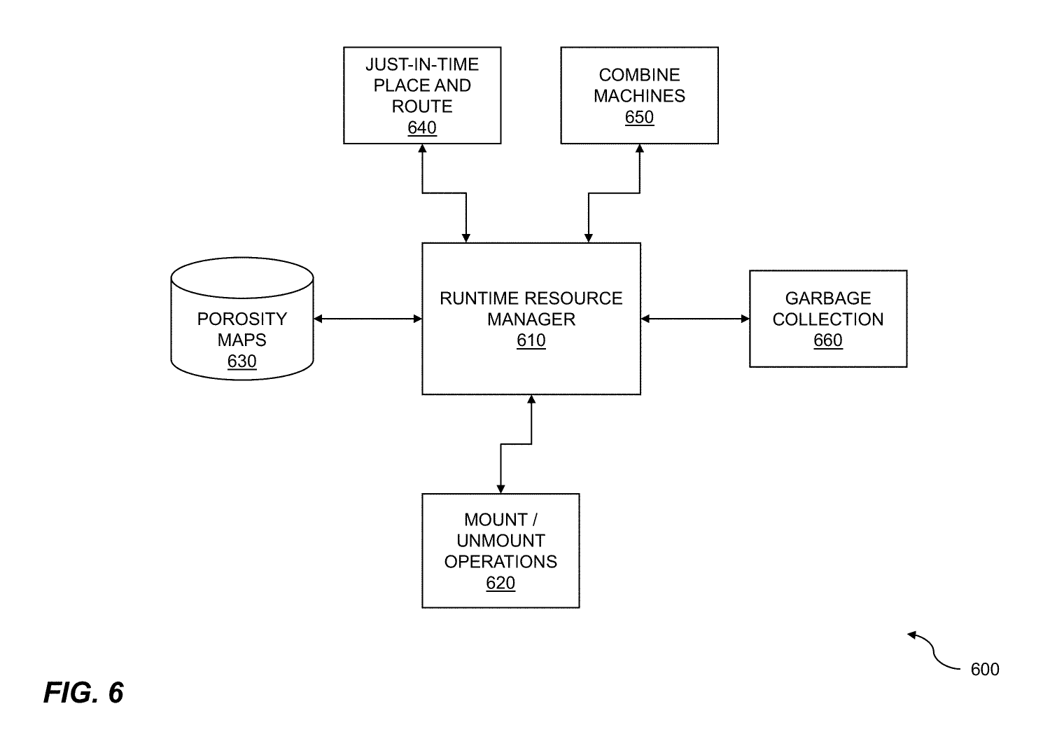

FIG. 6 illustrates an example block diagram for kernel mapping with porosity map. A porosity map can be used for kernel mapping, where the kernel mapping can be used for reconfigurable fabric data routing. A plurality of kernels is allocated across a reconfigurable fabric which includes a plurality of clusters, where the plurality of kernels includes at least a first kernel and a second kernel. The clusters can include processing elements, switching elements, storage elements, circular buffers for scheduling, and so on. The first kernel is mounted in a first set of clusters, and a second kernel is mounted in a second set of clusters. Available routing is determined through the second set of clusters. A porosity map through the second set of clusters is calculated based on the available routing through the second set of clusters. Data is sent through the second set of clusters to the first set of clusters based on the porosity map. The available routing through the second set of clusters is based on data input needs for the first kernel, and can change during execution of the second kernel. The available routing is controlled with instructions in circular buffers within the second set of clusters.

A block diagram 600 is shown for kernel mapping with a porosity map. A porosity map through a set of clusters can be calculated based on available routing through the clusters. Kernel mapping techniques can include a runtime resource manager 610. The runtime resource manager can identify one or more kernels to be mounted in a set of clusters, determine clusters that are available for mounting kernels, requisition reconfigurable fabric inputs and outputs for data sending and data receiving, and so on. The runtime resource manager can call for mount and unmount operations 620. The mount and unmount operations can include mounting one or more kernels into clusters of the reconfigurable fabric, unmounting one or more kernels from clusters of the reconfigurable fabric, etc. The techniques used for mounting the kernels can be based on online placement and routing algorithms. The unmount techniques can remove paths through kernels, where the paths are based on porosity maps. The runtime resource manager can access one or more porosity maps 630. The one or more porosity maps, which can include the porosity maps through one or more clusters, can be calculated based on determining available routing through the clusters, can be uploaded by a user, downloaded over a computer network, etc. The runtime resource manager can request just-in-time place and route 640 techniques. The place and route techniques can include mounting kernels into allocated clusters, calculating porosity maps through mounted clusters, and so on. The routing can be based on a variety of placement and routing techniques, heuristics, and algorithms including an A* algorithm, Dijkstra's algorithm, etc. The runtime resource manager can combine machines 650. Combining machines can be used for mounting large kernels, where the kernels may be larger than the available clusters to which the kernel might be allocated. The kernels can be partitioned into sub-kernels, where the sub-kernels may be small enough to mount onto available clusters. The results from the sub-kernels can be combined using one or more combining machines. The runtime resource manager can request periodic garbage collection 660. Garbage collection can be used for memory management to reclaim freed up memory. Garbage collection can be used to remove unused porosity maps, routing information, determined routes, mount tables, and so on.

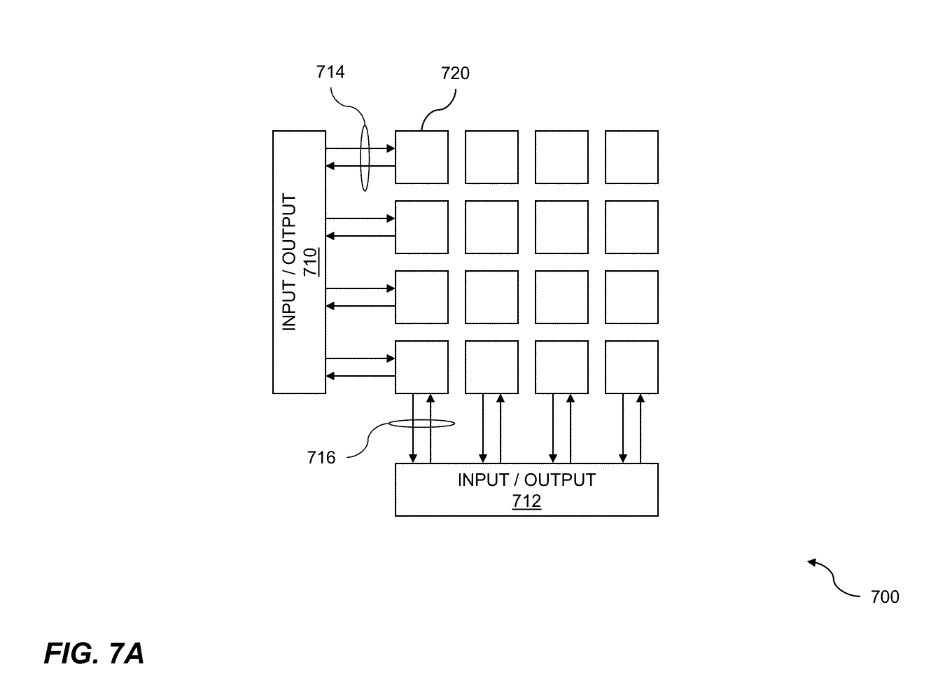

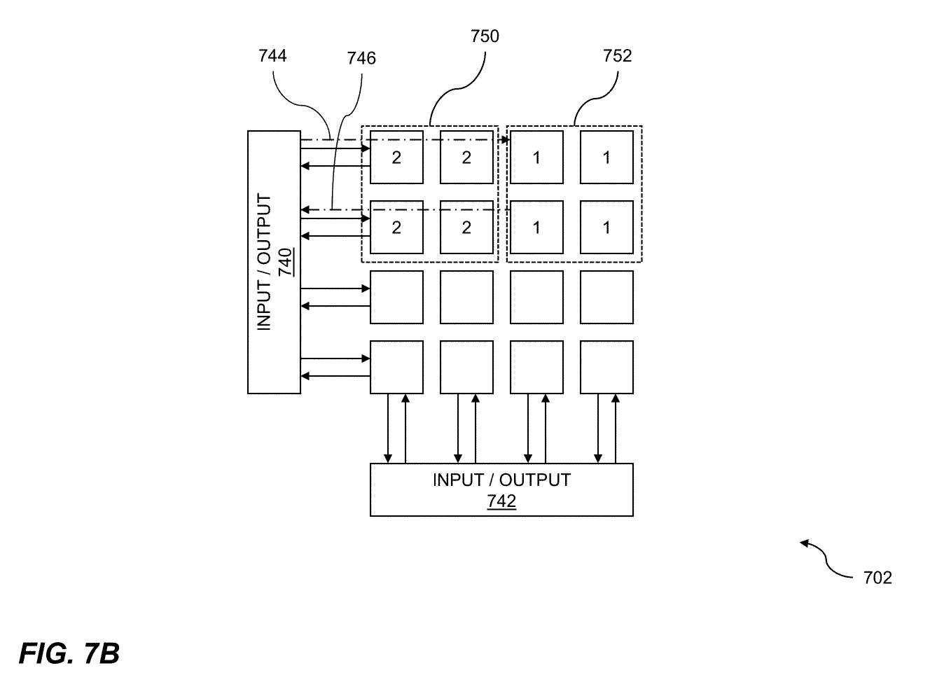

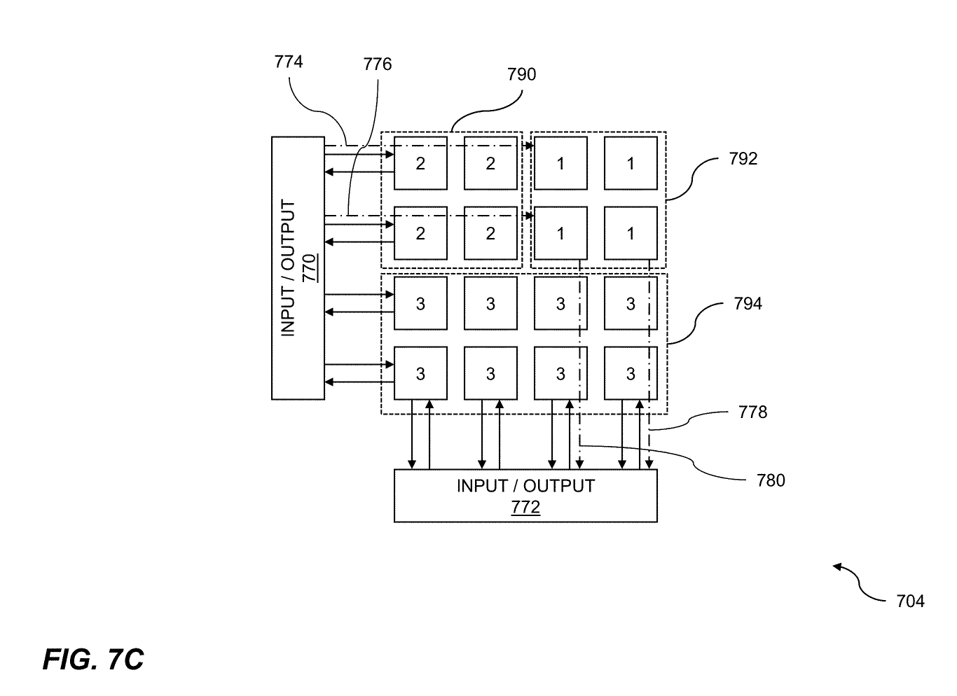

FIG. 7A shows a block diagram of a reconfigurable fabric showing clusters and fabric input/output. Clusters can be allocated to kernels, and inputs/outputs can be designated for reconfigurable fabric data routing. Software kernels are allocated across a reconfigurable fabric that includes multiple clusters, where software kernels include at least a first kernel and a second kernel. The first kernel is mounted in a first set of clusters within the multiple clusters, and the second kernel is mounted in a second set of clusters within the multiple clusters. Available routing through the second set of clusters is determined. A porosity map through the second set of clusters is calculated based on the available routing through the second set of clusters. The porosity map can indicate paths along which data can route through the second set of clusters. Data is sent through the second set of clusters to the first set of clusters based on the porosity map.

An example reconfigurable fabric 700 includes clusters and communications ports. The clusters can include elements, where the elements can be configured to perform various tasks within the reconfigurable fabric. In embodiments, the elements can be configured to perform tasks such as a processing element (PE), a switching element (SE), and storage element (STE), and so on. The configuring of the elements of the reconfigurable fabric can include scheduling one or more circular buffers, where the circular buffers can be scheduled statically. The schedules within the circular buffers configure and control the various elements within the reconfigurable fabric. The schedule of a circular buffer, which can include code, instructions, algorithms, heuristics, and so on, can further include a kernel, an agent, and the like. The reconfigurable fabric can include input/output ports 710 for east-west communication within the reconfigurable fabric. The reconfigurable fabric can include input/output ports 712 for north-south communication within the reconfigurable fabric. The input/output ports 710 and input/output ports 712 can include input ports, output ports, in-out (bidirectional) ports, and so on. The input/output ports 710 can support east-west communications 714 with one or more clusters such as cluster 720. Similarly, input/output ports 712 can support north-south communications 716 with one or more clusters.

FIG. 7B shows an example reconfigurable fabric with kernel 1 and kernel 2 mounted and with input and output for kernel 1 via kernel 2. The kernels, kernel 1 and kernel 2, can be mounted in a reconfigurable fabric and input/output routes or paths can be determined. The kernel mounting and path routing include reconfigurable fabric data routing. A plurality of kernels is allocated across a reconfigurable fabric which includes a plurality of clusters, where the plurality of kernels includes at least a first kernel and a second kernel. The clusters can include processing elements, switching elements, storage elements, communications paths, and so on. The first kernel is mounted in a first set of clusters within the plurality of clusters, and a second kernel is mounted in a second set of clusters within the plurality of clusters. Available routing through the second set of clusters is determined. A porosity map through the second set of clusters is calculated based on the available routing through the second set of clusters. Data is sent through the second set of clusters to the first set of clusters based on the porosity map. The available routing through the second set of clusters can change during execution of the second kernel.

A reconfigurable fabric 702 is shown which includes input/output ports 740 and additional input/output ports 742. Kernels, including software kernels, can be mounted in clusters of the reconfigurable fabric. In the example, kernel 1 is mounted in a first allocation of clusters 752, and kernel 2 is mounted in a second allocation of clusters 750. Since kernel 1 may not have direct communication with input and output ports such as input/output ports 740, routes through kernel 2 for inputs and routes through kernel 2 for outputs are be determined. A porosity map through the second set of clusters 750 can be calculated based on the available routing through the second set of clusters. An example input route 744 and an example output route 746 are shown. In embodiments, both of routes 744 and 746 can be input routes, output routes, in/out (bidirectional) routes, and so on. In embodiments, the available routing through the second set of clusters can change during execution of the second kernel. If the route through the second set of clusters assigned to the second kernel changes, then new routing can be determined, and a new porosity chart can be calculated.

FIG. 7C shows an example reconfigurable fabric with kernel 1, kernel 2, and kernel 3 mounted. An output from kernel 1 is routed via kernel 3. A third kernel can be mounted, and output routes through the third kernel can be determined for reconfigurable fabric data routing. A reconfigurable fabric cluster topology with route-through communication can be used for reconfigurable fabric data routing. Software kernels are allocated across a reconfigurable fabric that includes multiple clusters, where software kernels include at least a first kernel and a second kernel. The first kernel is mounted in a first set of clusters within the multiple clusters, and the second kernel is mounted in a second set of clusters within the multiple clusters. Available routing through the second set of clusters is determined. A porosity map through the second set of clusters is calculated based on the available routing through the second set of clusters. The porosity map can indicate paths along which data can route through the second set of clusters. Data is sent through the second set of clusters to the first set of clusters based on the porosity map.

A reconfigurable fabric 704 is shown which includes clusters, input/output ports 770, and additional input/output ports 772. One or more kernels can be assigned pluralities of clusters, and the kernels can be mounted in the allocated pluralities of clusters. Kernel 1 can be mounted in cluster 1 792, kernel 2 can be mounted in cluster 2 790, and kernel 3 can be mounted in cluster 3 794, and so on. Kernel 1 may not have direct communication with input ports, output ports, or input/output ports such as input/output ports 770 and input/output ports 772. For this example, kernel 1 can receive inputs through kernel 2 from input/output ports 770. Kernel 1 can send outputs through kernel 3 to input/output ports 772. As with the other examples, available routing through allocations of clusters must be determined for inputs to kernel one and for outputs from kernel 1. One or more porosity maps through the “blocking” or intermediate clusters are calculated based on the available routing through the clusters. Example input routes 774 and 776 are shown which route input data from input/output ports 770 through the cluster allocated to kernel 2 to kernel 1. Example output routes 778 and 780 are shown which route output data from kernel 1 through the cluster allocated to kernel 3 to input/output ports 772. In embodiments, the available routing through the second set of clusters can change during execution of the second kernel. In other embodiments, the available routing through the third set of clusters changes during execution of the third kernel. When the available routing changes, then one or more porosity maps can be calculated based on the available routing. New routes based on the porosity map can be used for routing input data, routing output data, and so on.

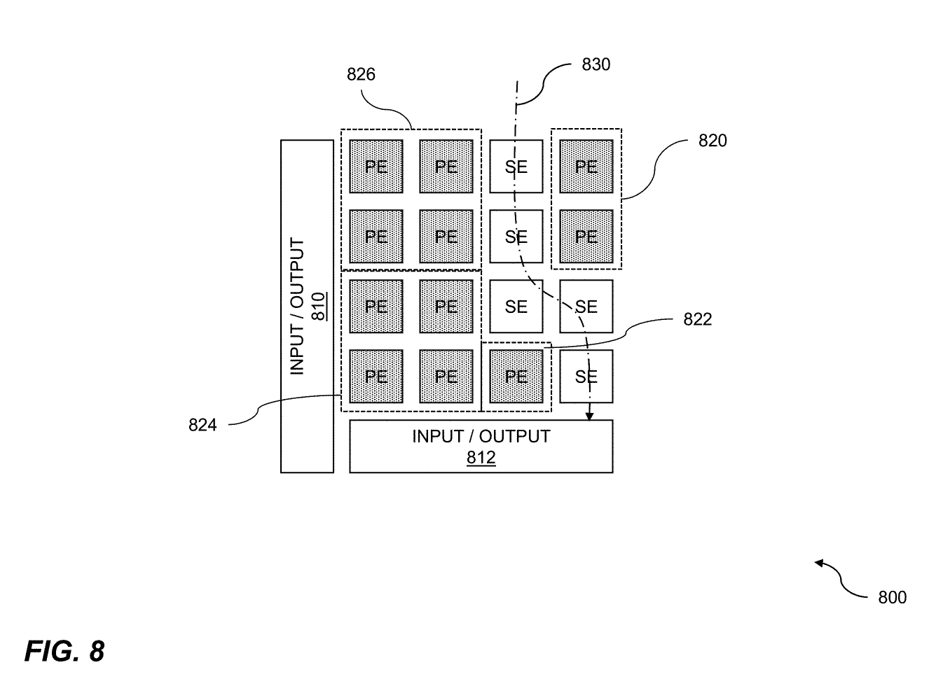

FIG. 8 is an example illustrating a porosity map. A porosity map can be calculated for reconfigurable fabric data routing. A plurality of kernels is allocated across a reconfigurable fabric which includes a plurality of clusters, where the plurality of kernels includes at least a first kernel and a second kernel. The clusters can include processing elements, switching elements, storage elements, and so on. The first kernel is mounted in a first set of clusters within the plurality of clusters, and a second kernel is mounted in a second set of clusters within the plurality of clusters. Available routing through the second set of clusters is determined. A porosity map through the second set of clusters is calculated based on the available routing through the second set of clusters. Data is sent through the second set of clusters to the first set of clusters based on the porosity map. The sending data through the second set of clusters can be based on data input needs for the first kernel. The available routing through the second set of clusters can change during execution of the second kernel.

An example for calculating a porosity map 800 is shown. A reconfigurable fabric can include one or more pluralities of clusters, where the clusters include reconfigurable elements. The reconfigurable elements can be configured to perform various functions, algorithms, or heuristics; to support various processing or analysis tasks; and so on. Within a reconfigurable fabric, reconfigurable elements can be configured as processing elements (PE), switching elements (SE), storage elements (STE), and so on. Communications to and from the reconfigurable fabric can be supported by ports, where the ports can include input ports, output ports, input/output (multidirectional) ports, and so on. East-west input/output ports 810, and north-south input/output ports 812 are shown. Other input ports, output ports, input/output ports, and so on can be coupled to the reconfigurable fabric. In example 800, four kernels have been allocated to clusters. A first kernel is allocated to a first cluster 820, a second kernel is allocated to a second cluster 822, a third kernel is allocated to a third cluster 824, and a fourth kernel is allocated to a fourth cluster 826. Other numbers of kernels can be allocated to other numbers of clusters. In the present example, four kernels are allocated to the four clusters 820, 822, 824, and 826; other clusters of elements remain unallocated. In embodiments, available routing through the unallocated clusters is determined. The available routing can include clusters that support nearest neighbor communication, clusters that support non-nearest neighbor communications, and so on. In embodiments, a porosity map can be calculated based on the available routing through the clusters. The clusters can be configured as switching elements (SE) to form a “route through” 830. With available routing determined, data can be sent through the clusters based on the porosity map. Since the available routing through the clusters can change during execution of a given kernel, the porosity map can change. Updated routes can be determined, and data can be sent using the updated routes.

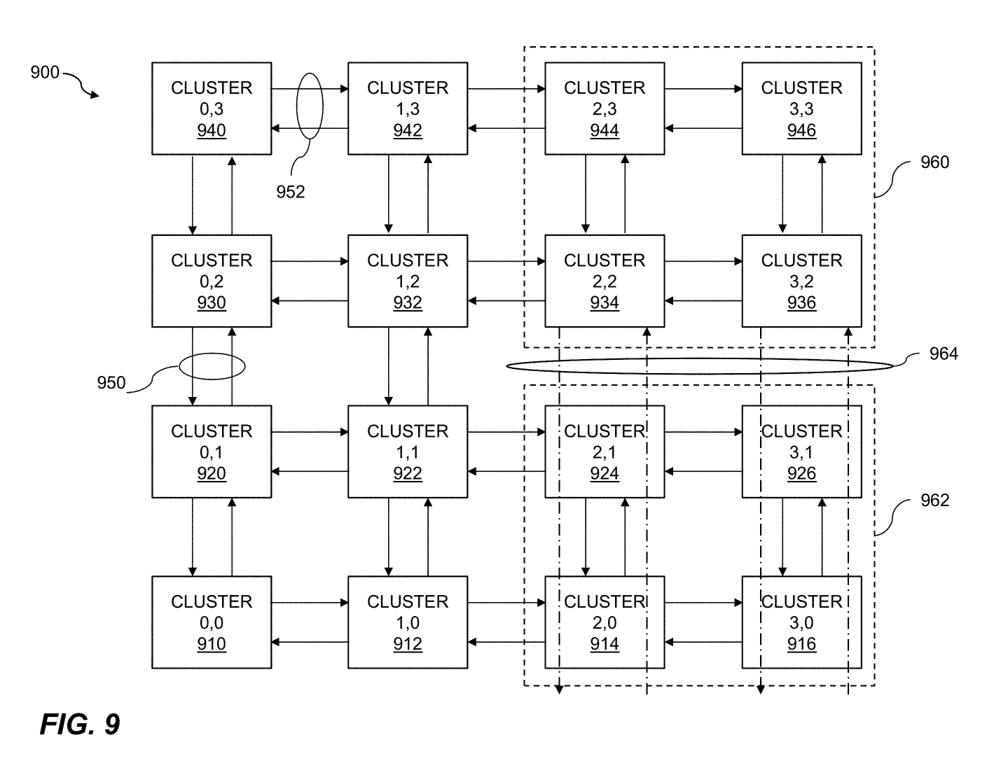

FIG. 9 shows a reconfigurable fabric cluster topology with route-through communication. A reconfigurable fabric cluster topology with route-through communication can be used for reconfigurable fabric data routing. The reconfigurable fabric cluster can be programmed, set, or otherwise configured to support communications between or among kernels, agents, clusters, and so on. A plurality of software kernels is allocated across a reconfigurable fabric that includes multiple clusters, where software kernels include at least a first kernel and a second kernel. The first kernel is mounted in a first set of clusters within the multiple clusters, and the second kernel is mounted in a second set of clusters within the multiple clusters. Available routing is determined through the second set of clusters. A porosity map is calculated through the second set of clusters based on the available routing through the second set of clusters. The porosity map can indicate paths along which data can be routed through the second set of clusters. Data is sent through the second set of clusters to the first set of clusters based on the porosity map.

As noted throughout, data can be sent along paths or routes that may exist through a plurality of clusters within a reconfigurable fabric. The aggregated paths, or porosity map, can be based on the available routing, where the available routing can be dependent on various factors. Embodiments include evaluating data input needs for the first kernel. The data input needs of the first kernel can include a type of data such as fixed point data, matrices, tensors, arrays, etc. The data input needs can also include an amount of data, the source of the data, the location of the data (e.g. within a reconfigurable fabric or beyond the reconfigurable fabric), and the like. In embodiments, the sending data through the second set of clusters can based on data input needs for the first kernel. The sending of the data to a kernel can be controlled. Embodiments include controlling the available routing with instructions in circular buffers within the second set of clusters. The routing through a cluster such as the cluster mounted with the second kernel, can be dependent upon instructions, code, schedules, etc., of the second kernel. In embodiments, the available routing through the second set of clusters is a function of operations being performed by the second kernel. The routing through the second set of clusters can be dynamic. In embodiments, the available routing through the second set of clusters changes during execution of the second kernel.

A fabric of clusters 900 can include a cluster of processing elements (PE) comprising a reconfigurable fabric. The reconfigurable fabric can include a plurality of interconnected clusters. In the example figure, a cluster 930 has a cluster 940 to its north, a cluster 932 to its east and a cluster 920 to its south. The cluster 930 exchanges data 950 with the southerly cluster 920 by using a south output connected to a north input of the cluster 920. Similarly, a south input of the cluster 930 is connected to a north output of the cluster 920. The cluster 940 exchanges data 952 with the cluster 942 oriented to the first cluster's east by using an east output connected to a west input of the second cluster 942. Similarly, an east input of cluster 940 is connected to a west output of cluster 942. In embodiments, the switching fabric is implemented with a parallel bus, such as a 32-bit bus. Other bus widths are possible, including, but not limited to, 16-bit, 64-bit, and 128-bit buses. Therefore, the configurable connections can provide for routing of a plurality of signals in parallel. In embodiments, the plurality of signals comprises four bytes. Communication through the configurable connections can be based on data being valid.

The fabric of clusters shown in FIG. 9 is a two-dimensional (2D) fabric, illustrating a mesh interconnection network where the clusters are placed in a two-dimensional grid. Each cluster is connected to its immediate neighbors as described in the case of the previously mentioned clusters as well as other clusters 910, 912, 914, 916, 922, 924, 926, 932, 934, 936, 944, and 946. Hence, in embodiments, the switching fabric is used in mesh computing. Other embodiments have a fabric of more than two dimensions. The configurable connections can provide three-dimensional (3D) routing. A three-dimensional (3D) embodiment can have additional cluster interconnectivity. In one embodiment, the 3D fabric is formed by layering multiple 2D mesh interconnect fabrics. The three-dimensional routing can include accessing a stacked chip. The stacked chip can be a 3D-integrated circuit where multiple die are stacked and interconnected with through-silicon vias (TSV). In the case of three-dimensional routing, each cluster can have additional input and output ports. For example, in addition to the north, south, east, and west I/O ports, sets of up and down I/O ports can be present in each cluster to allow connectivity to clusters situated above and below a certain cluster. In embodiments, the configurable connections comprise a switching fabric that is attached to a plurality of processing elements. The configurable connections can route through one or more of silicon vias, two-dimensional connections, three-dimensional connections, or greater than three-dimensional connections.

For example, a setup such as a hypercube can allow for greater than three-dimensional interconnectivity. With n-dimensional hypercubes, the interconnection topology can comprise a plurality of clusters and a plurality of links, with “n” being an integer greater than or equal to three. Each cluster has a degree “n,” meaning that it is connected with links to “n” other clusters. The configurable connections can enable the bypassing of neighboring logical elements. In embodiments, some or all of the clusters in the fabric have a direct connection to a non-adjacent (non-neighboring) cluster. In embodiments, some or all of the clusters in the fabric have a direct connection to non-neighboring clusters using settable routes through neighboring clusters. The settable routes can include “route-throughs”. Within the fabric, each cluster of the plurality of clusters can have its own circular buffer. Therefore, the example fabric of clusters 900 includes a plurality of circular buffers. The plurality of circular buffers can have differing lengths. For example, the cluster 930 can have a circular buffer of length X, while the cluster 932 can have a circular buffer with a length of X+Y. In such a configuration, the cluster 930 sleeps after execution of the X−1 stage until the cluster 932 executes the X+Y−1 stage, at which point the plurality of circular buffers having differing lengths can resynchronize with the zeroth pipeline stage for each of the plurality of circular buffers. In an example where X=6 and Y=2, after the execution of a fifth stage, the cluster 930 sleeps until the cluster 932 executes the seventh stage, at which point both pipelines resynchronize and start executing the same stage together. The clusters (910-946) can be configured to function together to process data and produce a result. The result can be stored in one of the storage elements of a cluster. In some embodiments, the result is stored across multiple clusters. In embodiments, the switching fabric includes fan-in and fan-out connections. In embodiments, the storage elements store data while the configurable connections are busy with other data.

A first kernel, such as a software kernel, can be allocated to a first plurality of clusters 960. While a plurality of four clusters, clusters 934, 936, 944, and 946, is shown, other numbers of clusters can be included in a plurality of clusters. A second kernel can be allocated to a second plurality of clusters 962. Similarly, the second kernel can occupy the same number of clusters as the first kernel, or a different number of clusters from the first kernel. The first kernel allocated to the first plurality of clusters 960 may not have direct connections, nearest neighbor connection, or other connections to input ports and output ports (not shown) of the reconfigurable fabric of which the various clusters are a part. Communications between the clusters allocated to the first kernel and the input ports and the output ports of the reconfigurable fabric can be established by determining available routes through the clusters allocated to the second kernel 964. These communication routes 964 can be established through the clusters allocated to the second kernel by calculating a porosity map through the second set of clusters. The porosity map can include data regarding elements of the second cluster that can be assigned as switching elements, where the switching elements can be coupled together to form a communication route. The switching elements can be “switched on” to establish one or more communication routes through the second cluster. In embodiments, the available routing through the second set of clusters changes during execution of the second kernel.

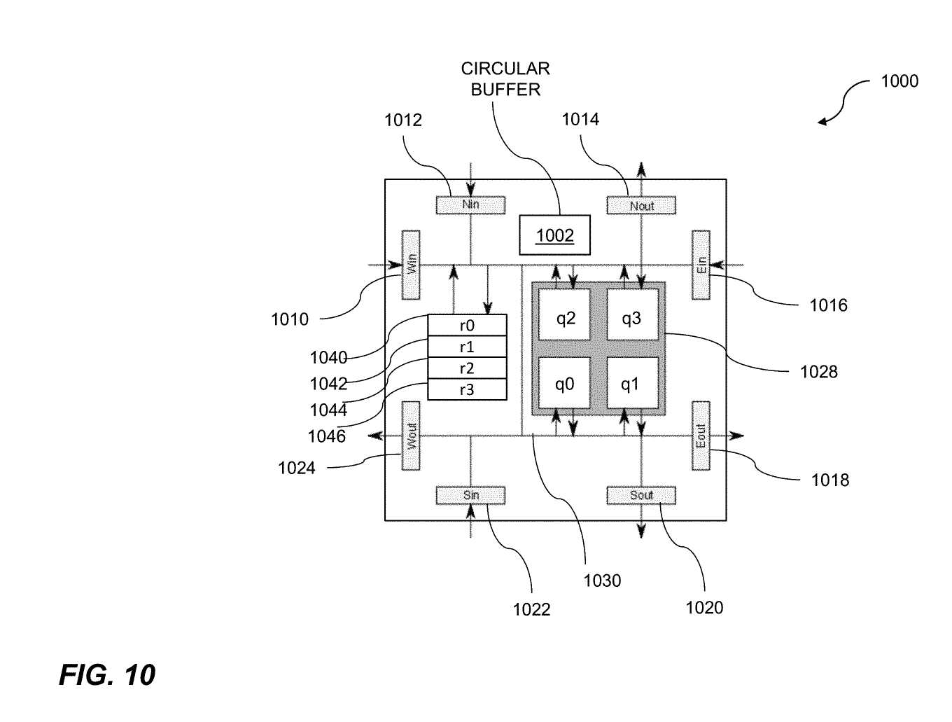

FIG. 10 shows a cluster for coarse-grained reconfigurable processing. The cluster 1000 for coarse-grained reconfigurable processing can be used for reconfigurable fabric data routing. The reconfigurable fabric data routing includes allocating a plurality of kernels across a reconfigurable fabric which includes a plurality of clusters, where the plurality of kernels includes at least a first kernel and a second kernel. The clusters can include processing elements, switching elements, storage elements, and so on. The first kernel is mounted in a first set of clusters within the plurality of clusters, and a second kernel is mounted in a second set of clusters within the plurality of clusters. Available routing is determined through the second set of clusters. A porosity map through the second set of clusters is calculated based on the available routing through the second set of clusters. Data is sent through the second set of clusters to the first set of clusters based on the porosity map. The available routing through the second set of clusters can be a function of operations being performed by the second kernel, and the available routing can change during execution of the second kernel.

The cluster 1000 comprises a circular buffer 1002. The circular buffer 1002 can be referred to as a main circular buffer or a switch-instruction circular buffer. In some embodiments, the cluster 1000 comprises additional circular buffers corresponding to processing elements within the cluster. The additional circular buffers can be referred to as processor instruction circular buffers. The example cluster 1000 comprises a plurality of logical elements, configurable connections between the logical elements, and a circular buffer 1002 controlling the configurable connections. The logical elements can further comprise one or more of switching elements, processing elements, or storage elements. The example cluster 1000 also comprises four processing elements—q0, q1, q2, and q3. The four processing elements can collectively be referred to as a “quad,” and can be jointly indicated by a grey reference box 1028. In embodiments, there is intercommunication among and between each of the four processing elements. In embodiments, the circular buffer 1002 controls the passing of data to the quad of processing elements 1028 through switching elements. In embodiments, the four processing elements 1028 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 1000 can further comprise storage elements coupled to the configurable connections. As shown, the cluster 1000 comprises four storage elements—r0 1040, r1 1042, r2 1044, and r3 1046. The cluster 1000 further comprises a north input (Nin) 1012, a north output (Nout) 1014, an east input (Ein) 1016, an east output (Eout) 1018, a south input (Sin) 1022, a south output (Sout) 1020, a west input (Win) 1010, and a west output (Wout) 1024. The circular buffer 1002 can contain switch instructions that implement configurable connections. For example, an instruction effectively connects the west input 1010 with the north output 1014 and the east output 1018 and this routing is accomplished via bus 1030. The cluster 1000 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 1002. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 1024 to an instruction placing data on the south output 1020, such that the data can be output on both output ports within the same pipeline cycle. In a case where data needs to travel to a cluster that is both south and west of the cluster 1000, it can be more efficient to send the data directly to the south output port rather than to store the data in a register first, and then to send the data to the west output on a subsequent pipeline cycle.

An L2 switch interacts with the instruction set. A switch instruction typically has both a source and a destination. Data is accepted from the source and sent to the destination. There are several sources (e.g. any of the quads within a cluster, any of the L2 directions—North, East, South, West, a switch register, or one of the quad RAMs-data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in excessive instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can perform any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAMs in different clusters can travel through the same DMA path, but the transactions must be separately defined. A maximum block size for a single DMA transfer can be 8 KB. Accesses to data RAMs can be performed either when the processors are running or while the processors are in a low power “sleep” state. Accesses to the instruction RAMs and the PE and Co-Processor Registers may be performed during configuration mode. The quad RAMs may have a single read/write port with a single address decoder, thus allowing shared access by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

In embodiments, the computations that can be performed on a cluster for coarse-grained reconfigurable processing can be represented by a data flow graph. Data flow processors, data flow processor elements, and the like, are particularly well suited to processing the various nodes of data flow graphs. The data flow graphs can represent communications between and among agents, matrix computations, tensor manipulations, Boolean functions, and so on. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of high quality data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in configurations such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the clusters enter the configuration mode, various techniques, including direct memory access (DMA) can be used to load instructions from the kernel into instruction memories of the PEs. The clusters that were preprogrammed configuration mode can also be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as those based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents that are resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals, but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to fully vacant because a fire signal might be sent to the agent by the upstream agent. When the upstream agent is partially resident or is fully vacant, then the agent can be fully vacated from the reconfigurable fabric. The agent can be fully vacated if it asserts both the input buffers empty and output buffers empty signals.

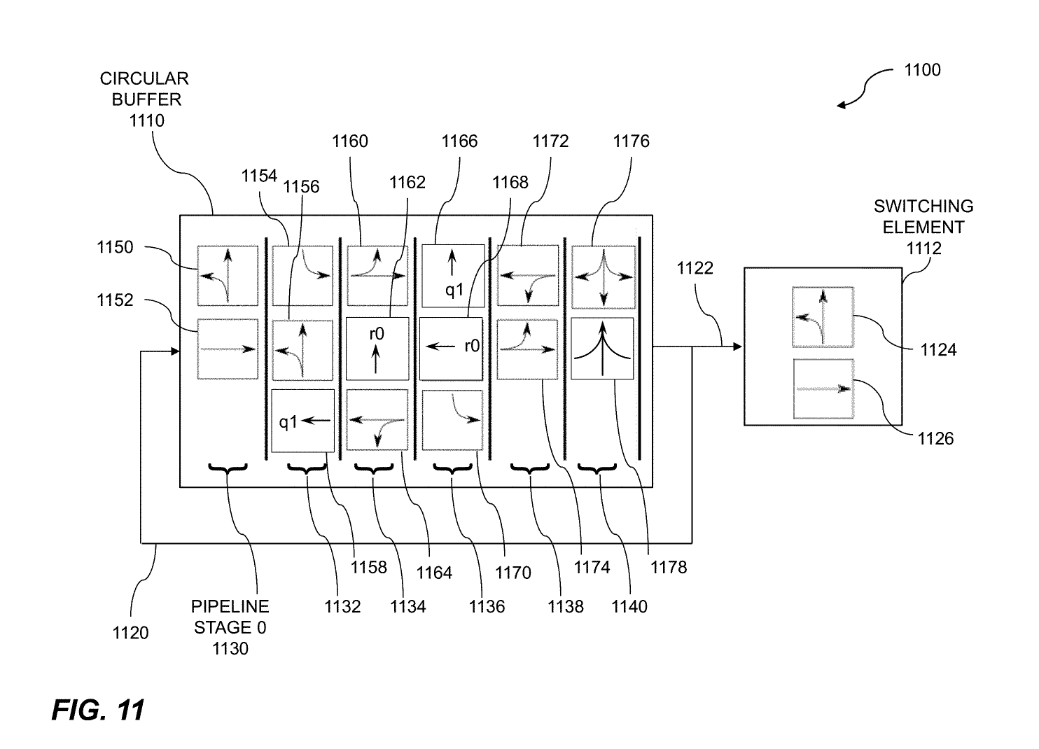

FIG. 11 shows a block diagram of a circular buffer. The circular buffer 1100 can include a switching element 1112 corresponding to the circular buffer. The circular buffer and the corresponding switching element can be used in part for reconfigurable fabric data routing. Using the circular buffer 1110 and the corresponding switching element 1112, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 1100 describes a processor-implemented method for data manipulation. The circular buffer 1110 contains a plurality of pipeline stages. Each pipeline stage contains one or more instructions, up to a maximum instruction depth. In the embodiment shown in FIG. 11, the circular buffer 1110 is a 6×3 circular buffer, meaning that it implements a six-stage pipeline with an instruction depth of up to three instructions per stage (column). Hence, the circular buffer 1110 can include one, two, or three switch instruction entries per column. In some embodiments, the plurality of switch instructions per cycle can comprise two or three switch instructions per cycle. However, in certain embodiments, the circular buffer 1110 supports only a single switch instruction in a given cycle. In the example 1100 shown, Pipeline Stage 0 1130 has an instruction depth of two instructions 1150 and 1152. Though the remaining pipeline stages 1-5 are not textually labeled in the FIG. 1100, the stages are indicated by callouts 1132, 1134, 1136, 1138, and 1140. Pipeline stage 1 1132 has an instruction depth of three instructions 1154, 1156, and 1158. Pipeline stage 2 1134 has an instruction depth of three instructions 1160, 1162, and 1164. Pipeline stage 3 1136 also has an instruction depth of three instructions 1166, 1168, and 1170. Pipeline stage 4 1138 has an instruction depth of two instructions 1172 and 1174. Pipeline stage 5 1140 has an instruction depth of two instructions 1176 and 1178. In embodiments, the circular buffer 1110 includes 64 columns. During operation, the circular buffer 1110 rotates through configuration instructions. The circular buffer 1110 can dynamically change operation of the logical elements based on the rotation of the circular buffer. The circular buffer 1110 can comprise a plurality of switch instructions per cycle for the configurable connections.

The instruction 1152 is an example of a switch instruction. In embodiments, each cluster has four inputs and four outputs, each designated within the cluster's nomenclature as “north,” “east,” “south,” and “west” respectively. For example, the instruction 1152 in the diagram 1100 is a west-to-east transfer instruction. The instruction 1152 directs the cluster to take data on its west input and send out the data on its east output. In another example of data routing, the instruction 1150 is a fan-out instruction. The instruction 1150 instructs the cluster to take data from its south input and send out on the data through both its north output and its west output. The arrows within each instruction box indicate the source and destination of the data. The instruction 1178 is an example of a fan-in instruction. The instruction 1178 takes data from the west, south, and east inputs and sends out the data on the north output. Therefore, the configurable connections can be considered to be time multiplexed.

In embodiments, the clusters implement multiple storage elements in the form of registers. In the example 1100 shown, the instruction 1162 is a local storage instruction. The instruction 1162 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is complete. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep and awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 1158 is a processing instruction. The instruction 1158 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 1100 shown, the circular buffer 1110 rotates instructions in each pipeline stage into switching element 1112 via a forward data path 1122, and also back to a pipeline stage 0 1130 via a feedback data path 1120. Instructions can include switching instructions, storage instructions, and processing instructions, among others. The feedback data path 1120 can allow instructions within the switching element 1112 to be transferred back to the circular buffer. Hence, the instructions 1124 and 1126 in the switching element 1112 can also be transferred back to pipeline stage 0 as the instructions 1150 and 1152. In addition to the instructions depicted on FIG. 11, a no-op instruction can also be inserted into a pipeline stage. In embodiments, a no-op instruction causes execution to not be performed for a given cycle. In effect, the introduction of a no-op instruction can cause a column within the circular buffer 1110 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 1158, assuming that the processor q1 was previously in a sleep state. In embodiments, when the instruction 1158 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 1166. In the case of the instruction 1166, data from the processor q1 is moved to the north output. In some embodiments, if Xs have been placed into the processor q1, such as during the instruction 1158, then Xs would be retrieved from the processor q1 during the execution of the instruction 1166 and would be applied to the north output of the instruction 1166.

A collision occurs if multiple instructions route data to a particular port in a given pipeline stage. For example, if instructions 1152 and 1154 are in the same pipeline stage, they will both send data to the east output at the same time, thus causing a collision since neither instruction is part of a time-multiplexed fan-in instruction (such as the instruction 1178). To avoid potential collisions, certain embodiments use preprocessing, such as by a compiler, to arrange the instructions in such a way that there are no collisions when the instructions are loaded into the circular buffer. Thus, the circular buffer 1110 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 1162), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will make sure the memory bit is reset to 0 which thereby prevents a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

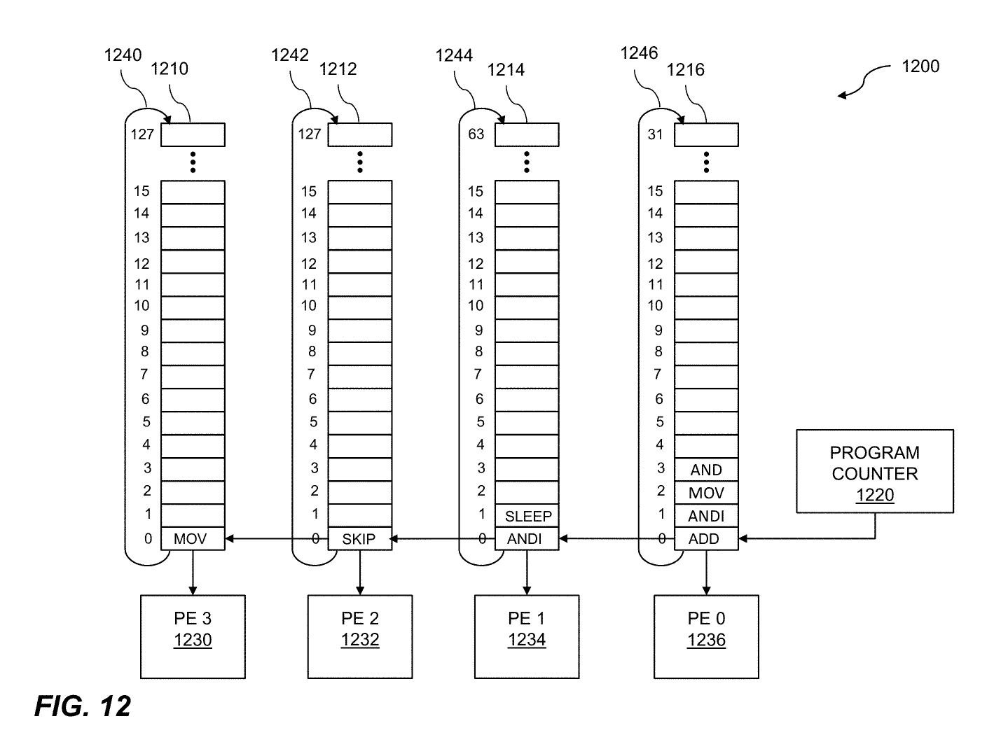

FIG. 12 illustrates circular buffers and processing elements. A diagram 1200 indicates example instruction execution for processing elements. The processing elements can include a portion of or all of the elements within a reconfigurable fabric. The instruction execution can include instructions for reconfigurable fabric data routing. A plurality of kernels is allocated across a reconfigurable fabric which includes a plurality of clusters, where the plurality of kernels includes at least a first kernel and a second kernel. The clusters can include processing elements, switching elements, storage elements, and so on. The first kernel is mounted in a first set of clusters, and a second kernel is mounted in a second set of clusters. Available routing is determined through the second set of clusters. A porosity map through the second set of clusters is calculated based on the available routing through the second set of clusters. Data is sent through the second set of clusters to the first set of clusters based on the porosity map. The available routing through the second set of clusters can change during execution of the second kernel.

A circular buffer 1210 feeds a processing element 1230. A second circular buffer 1212 feeds another processing element 1232. A third circular buffer 1214 feeds another processing element 1234. A fourth circular buffer 1216 feeds another processing element 1236. The four processing elements 1230, 1232, 1234, and 1236 can represent a quad of processing elements. In embodiments, the processing elements 1230, 1232, 1234, and 1236 are controlled by instructions received from the circular buffers 1210, 1212, 1214, and 1216. The circular buffers can be implemented using feedback paths 1240, 1242, 1244, and 1246, respectively. In embodiments, the circular buffer can control the passing of data to a quad of processing elements through switching elements, where each of the quad of processing elements is controlled by four other circular buffers (as shown in the circular buffers 1210, 1212, 1214, and 1216) and where data is passed back through the switching elements from the quad of processing elements where the switching elements are again controlled by the main circular buffer. In embodiments, a program counter 1220 is configured to point to the current instruction within a circular buffer. In embodiments with a configured program counter, the contents of the circular buffer are not shifted or copied to new locations on each instruction cycle. Rather, the program counter 1220 is incremented in each cycle to point to a new location in the circular buffer. The circular buffers 1210, 1212, 1214, and 1216 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

In some embodiments, the circular buffers 1210, 1212, 1214, and 1216 could all have the same length, for example, 128 instructions. However, in other embodiments, the plurality of circular buffers can have differing lengths. That is, the plurality of circular buffers can comprise circular buffers of differing sizes. As shown in FIG. 12, the first two circular buffers 1210 and 1212 have a length of 128 instructions, the third circular buffer 1214 has a length of 64 instructions, and the fourth circular buffer 1216 has a length of 32 instructions, but other circular buffer lengths are also possible. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 12, different circular buffers can have different instruction sets within them. For example, the first circular buffer 1210 contains a MOV instruction. The second circular buffer 1212 contains a SKIP instruction. The third circular buffer 1214 contains a SLEEP instruction and an ANDI instruction. The fourth circular buffer 1216 contains an AND instruction, a MOVE instruction, an ANDI instruction, and an ADD instruction. The operations performed by the processing elements 1230, 1232, 1234, and 1236 are dynamic and can change over time, based on the instructions loaded into the respective circular buffers. As the circular buffers rotate, new instructions can be executed by the respective processing element.

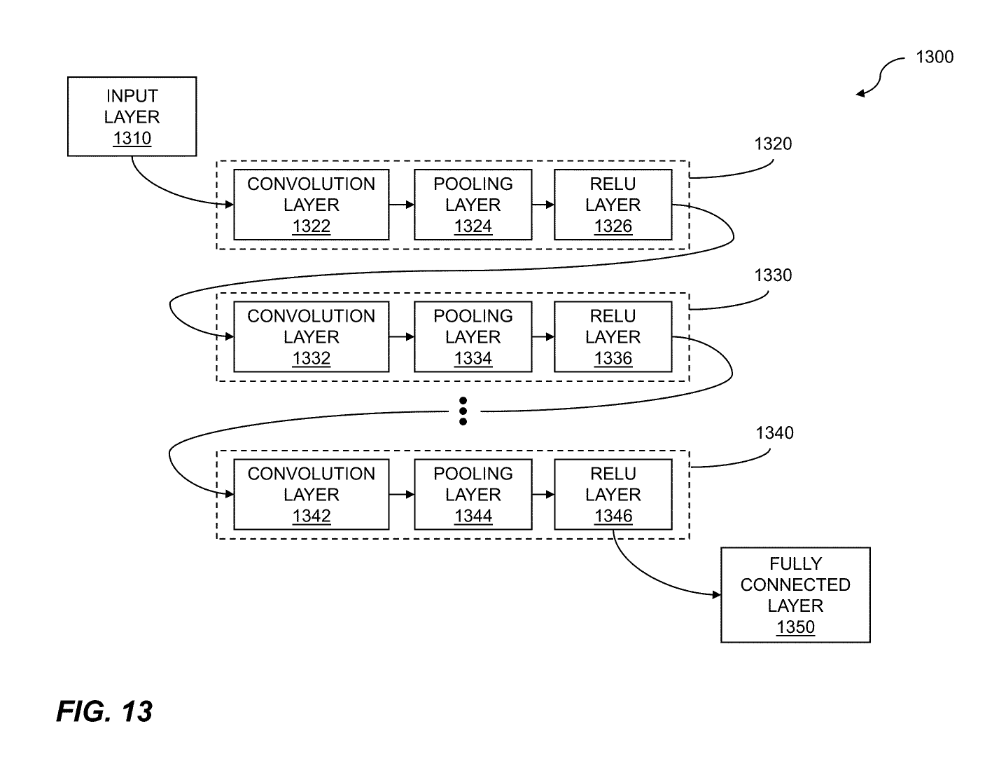

FIG. 13 shows a deep learning block diagram. The deep learning block diagram 1300 can include a neural network such as a deep neural network (DNN), a convolutional neural network (CNN), a recurrent neural network (RNN), and so on. A convolutional neural network or other neural network can be based on layers, where the layers can include input layers, output layers, fully connected layers, convolution layers, pooling layers, rectified linear unit (ReLU) layers, and so on. The layers can include machine learned layers for reconfigurable fabric data routing. The reconfigurable fabric can include processing elements, switching elements, storage elements, etc. The reconfigurable fabric can be used to perform various operations such as logical operations. Deep learning can support reconfigurable fabric data routing. A plurality of kernels is allocated across a reconfigurable fabric comprised of a plurality of clusters. The plurality of kernels includes at least a first kernel and a second kernel. The first kernel is mounted in a first set of clusters, and the second kernel is mounted in a second set of clusters. A porosity map through the second set of clusters is calculated based on the available routing through the second set of clusters, and data is sent through the second set of clusters to the first set of clusters.

The deep learning block diagram 1300 can include various layers, where the layers can include an input layer, hidden layers, a fully connected layer, and so on. In some embodiments, the deep learning block diagram can include a classification layer. The input layer 1310 can receive input data, where the input data can include a first obtained data group, a second obtained data group, a third obtained data group, a fourth obtained data group, etc. The obtaining of the data groups can be performed in a first locality, a second locality, a third locality, a fourth locality, and so on, respectively. The input layer can then perform processing such as partitioning obtained data into non-overlapping partitions. The deep learning block diagram 1300, which can represent a network such as a convolutional neural network, can contain a plurality of hidden layers. While three hidden layers, hidden layer 1320, hidden layer 1330, and hidden layer 1340 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 1320 can include convolution layer 1322, pooling layer 1324, and ReLU layer 1326; layer 1330 can include convolution layer 1332, pooling layer 1334, and ReLU layer 1336; and layer 1340 can include convolution layer 1342, pooling layer 1344, and ReLU layer 1346. The convolution layers 1322, 1332, and 1342 can perform convolution operations; the pooling layers 1324, 1334, and 1344 can perform pooling operations, including max pooling, such as data down-sampling; and the ReLU layers 1326, 1336, and 1346 can perform rectification operations. A convolutional layer can reduce the amount of data feeding into a fully connected layer. The deep learning block diagram 1300 can include a fully connected layer 1350. The fully connected layer can be connected to each data point from the one or more convolutional layers.

Data flow processors can be implemented within a reconfigurable fabric. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs configured in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the cluster enters the configuration mode, various techniques, including direct memory access (DMA) can be used to load instructions from the kernel into instruction memories of the PEs. The clusters that were pre-programmed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

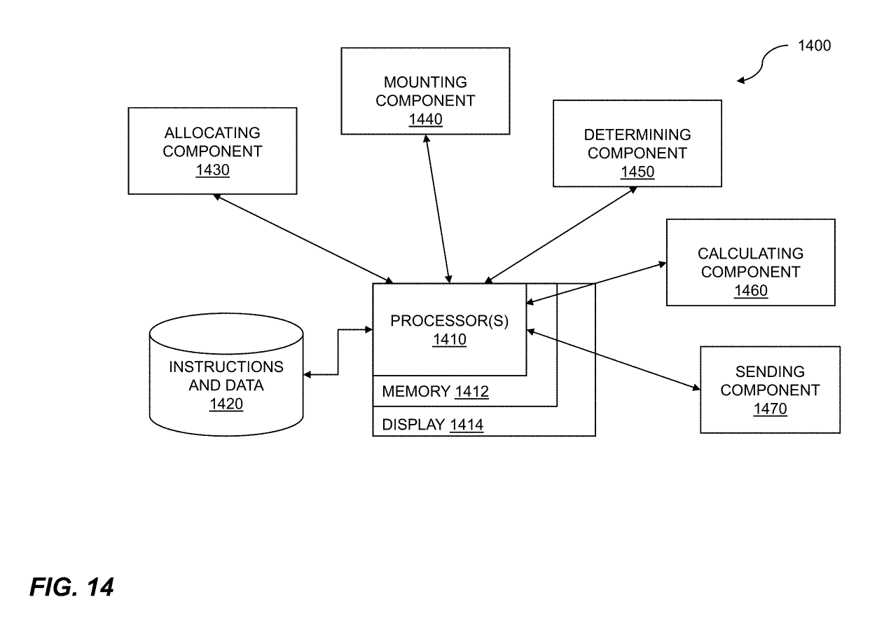

FIG. 14 is a system diagram for data manipulation for reconfigurable fabric data routing. The system 1400 can include one or more processors 1410 coupled to a memory 1412 which stores instructions. The system 1400 can include a display 1414 coupled to the one or more processors 1410 for displaying data, intermediate steps, instructions, and so on. In embodiments, one or more processors 1410 are attached to the memory 1412 where the one or more processors, when executing the instructions which are stored, are configured to: allocate a plurality of kernels across a reconfigurable fabric comprised of a plurality of clusters, wherein the plurality of kernels includes at least a first kernel and a second kernel; mount the first kernel in a first set of clusters within the plurality of clusters; mount the second kernel in a second set of clusters within the plurality of clusters; determine available routing through the second set of clusters; calculate a porosity map through the second set of clusters based on the available routing through the second set of clusters; and send data through the second set of clusters to the first set of clusters based on the porosity map.

The system 1400 can include a collection of instructions and data 1420. The instructions and data 1420 may be stored in a database, one or more statically linked libraries, one or more dynamically linked libraries, precompiled headers, source code, flow graphs, kernels, or other suitable formats. The instructions can include instructions for data routing from one or more kernels through another kernel within a reconfigurable fabric. The instructions can include satisfiability solver techniques, machine learning or deep learning techniques, neural network techniques, agents, and the like. The instructions can include mapping constraints, porosity maps, or satisfiability models.

The system 1400 can include an allocating component 1430. The allocating component 1430 can include functions and instructions for allocating a plurality of kernels across a reconfigurable fabric. The reconfigurable fabric can include clusters, where the clusters can include processing elements, switching elements, storage elements, communications paths, and so on. The plurality of kernels that is allocated includes at least a first kernel and a second kernel. The system 1400 can include a mounting component 1440. The mounting component 1440 can include functions and instructions for mounting a first kernel in a first set of clusters within the plurality of clusters, and functions and instructions for mounting a second kernel in a second set of clusters within the plurality of clusters. The mounting of the first kernel can be based on various criteria such as data needs, communication needs, or storage needs. Further embodiments include evaluating data input needs for the first kernel. Functions and instructions can be included for mounting other kernels such as a third kernel, a fourth kernel, and so on. In embodiments, the mounting of the first kernel in the first set of clusters and the second kernel in the second set of clusters is a function of porosity, as discussed throughout. The system 1400 can include a determining component 1450. The determining component 1450 can include functions and instructions for determining available routing through the second set of clusters. The available routing can be used for communicating data, intermediate data, signals such as fire signals and done signals, instructions, etc., between and among kernels that have been allocated to the reconfigurable fabric. Further embodiments include controlling the available routing with instructions in circular buffers within the second set of clusters.

The system 1400 can include a calculating component 1460. The calculating component 1460 can include functions and instructions for calculating a porosity map through the second set of clusters based on the available routing through the second set of clusters. The porosity map can include mapping of processing elements, switching elements, storage elements, and other elements that are allocated to kernels. The porosity map, and the available routing through a kernel can change during execution of a kernel. The porosity map can be recalculated based on changes to available routing through the kernel. The system 1400 can include a sending component 1470. The sending component 1470 can include functions and instructions for sending data through the second set of clusters to the first set of clusters based on the porosity map. The sending data through the second set of clusters can be based on the data input needs for the first kernel, the data output needs of the first kernel, and so on.

The system 1400 can include a computer program product embodied in a non-transitory computer readable medium for data manipulation, the computer program product comprising code which causes one or more processors to perform operations of: allocating a plurality of kernels across a reconfigurable fabric comprised of a plurality of clusters, wherein the plurality of kernels includes at least a first kernel and a second kernel; mounting the first kernel in a first set of clusters within the plurality of clusters; mounting the second kernel in a second set of clusters within the plurality of clusters; determining available routing through the second set of clusters; calculating a porosity map through the second set of clusters based on the available routing through the second set of clusters; and sending data through the second set of clusters to the first set of clusters based on the porosity map.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for data manipulation comprising:
allocating a plurality of kernels across a reconfigurable fabric comprised of a plurality of clusters, wherein the plurality of kernels includes at least a first kernel and a second kernel;
mounting the first kernel in a first set of clusters within the plurality of clusters;
mounting the second kernel in a second set of clusters within the plurality of clusters;
determining available routing through the second set of clusters;
calculating a porosity map through the second set of clusters based on the available routing through the second set of clusters; and
sending data through the second set of clusters to the first set of clusters based on the porosity map.

2. The method of claim 1 wherein the mounting of the first kernel in the first set of clusters and the second kernel in the second set of clusters is a function of porosity.

3. The method of claim 1 further comprising evaluating data input needs for the first kernel.

4. The method of claim 3 wherein the sending data through the second set of clusters is based on data input needs for the first kernel.

5. The method of claim 1 further comprising controlling the available routing with instructions in circular buffers within the second set of clusters.

6. The method of claim 1 further comprising storing the data in one or more registers within the second set of clusters.

7. The method of claim 6 wherein the storing is temporary in order to facilitate the sending of the data and avoiding congestion problems in the reconfigurable fabric.

8. The method of claim 1 wherein the available routing through the second set of clusters is a function of operations being performed by the second kernel.

9. The method of claim 8 wherein the available routing through the second set of clusters changes during execution of the second kernel.

10. The method of claim 8 wherein one or more portions of the second set of clusters are placed into a sleep state.

11. The method of claim 10 wherein circular buffers within the second set of clusters remain active to execute the sending.

12. The method of claim 8 wherein the function of the operations being performed by the second kernel changes due to reprogramming of the second set of clusters.

13. The method of claim 12 wherein the reprogramming of the second set of clusters does not impact the sending of the data.

14. The method of claim 1 wherein each cluster of the plurality of clusters comprising the reconfigurable fabric is controlled by one or more circular buffers.

15-16. (canceled)

17. The method of claim 1 wherein the first kernel mounted in the first set of clusters lacks direct access to fabric I/O ports for the reconfigurable fabric.

18. The method of claim 1 further comprising evaluating data output needs of the first kernel.

19. The method of claim 18 further comprising sending output data from the first kernel mounted on the first set of clusters through the second set of clusters to fabric I/O ports based on the porosity map.

20. The method of claim 18 further comprising mounting a third kernel in a third set of clusters within the plurality of clusters.

21. The method of claim 20 further comprising determining available routing through the third set of clusters.

22. The method of claim 21 further comprising calculating a porosity map through the third set of clusters based on the available routing through the third set of clusters.

23. The method of claim 22 further comprising sending output data from the first set of clusters through the third set of clusters based on the porosity map for routing through the third set of clusters.

24. The method of claim 1 further comprising updating the porosity map based on operation completion of the first kernel.

25. The method of claim 1 further comprising updating the porosity map based on operation completion of the second kernel.

26. (canceled)

27. The method of claim 1 wherein the first set of clusters within the plurality of clusters and the second set of clusters within the plurality of clusters are synchronized within the reconfigurable fabric.

28-30. (canceled)

31. A computer program product embodied in a non-transitory computer readable medium for data manipulation, the computer program product comprising code which causes one or more processors to perform operations of:
allocating a plurality of kernels across a reconfigurable fabric comprised of a plurality of clusters, wherein the plurality of kernels includes at least a first kernel and a second kernel;
mounting the first kernel in a first set of clusters within the plurality of clusters;
mounting the second kernel in a second set of clusters within the plurality of clusters;
determining available routing through the second set of clusters;
calculating a porosity map through the second set of clusters based on the available routing through the second set of clusters; and
sending data through the second set of clusters to the first set of clusters based on the porosity map.

32. A computer system for data manipulation comprising:
a memory which stores instructions;
one or more processors attached to the memory wherein the one or more processors, when executing the instructions which are stored, are configured to:
allocate a plurality of kernels across a reconfigurable fabric comprised of a plurality of clusters, wherein the plurality of kernels includes at least a first kernel and a second kernel;
mount the first kernel in a first set of clusters within the plurality of clusters;
mount the second kernel in a second set of clusters within the plurality of clusters;
determine available routing through the second set of clusters;
calculate a porosity map through the second set of clusters based on the available routing through the second set of clusters; and
send data through the second set of clusters to the first set of clusters based on the porosity map.
